(19) United States
(12) Patent Application Publication
(10) Pub. No.: US 2026/0113094 A1
(43) Pub. Date: Apr. 23, 2026

(54) UPLINK TRANSMISSION

(71) Applicant: Samsung Electronics Co., Ltd., Suwon-si (KR)

(72) Inventors: MD Saifur Rahman, Plano, TX (US); Eko Onggosanusi, Coppell, TX (US); Emad Nader Farag, Flanders, NJ (US); Gilwon Lee, Prosper, TX (US)

(21) Appl. No.: 19/347,683

(22) Filed: Oct. 1, 2025

Related U.S. Application Data
(60) Provisional application No. 63/710,382, filed on Oct. 22, 2024.
(60) Provisional application No. 63/717,061, filed on Nov. 6, 2024.
(60) Provisional application No. 63/723,458, filed on Nov. 21, 2024.
(60) Provisional application No. 63/738,323, filed on Dec. 23, 2024.
(60) Provisional application No. 63/743,111, filed on Jan. 8, 2025.

(51) Int. Cl. H04B 7/06; H04L 1/00; H04L 5/00

(52) U.S. Cl. CPC H04B 7/0626; H04L 1/0003; H04L 5/0044

(57) ABSTRACT

Apparatuses and methods for uplink (UL) transmission. A method performed by a user equipment (UE) includes receiving a downlink (DL) reference signal (RS) associated with a channel state information (CSI) report and measuring the DL RS. The method further includes determining an UL channel based on the measurement and transmitting the CSI report including information about the UL channel.

### CROSS-REFERENCE TO RELATED AND CLAIM OF PRIORITY

The present application claims priority under 35 U.S.C. § 119(e) to U.S. Provisional Patent Application No. 63/710,382 filed on Oct. 22, 2024; U.S. Provisional Patent Application No. 63/717,061 filed on Nov. 6, 2024; U.S. Provisional Patent Application No. 63/723,458 filed on Nov. 21, 2024; U.S. Provisional Patent Application No. 63/738,323 filed on Dec. 23, 2024; and U.S. Provisional Patent Application No. 63/743,111 filed on Jan. 8, 2025, which are hereby incorporated by reference in their entirety.

### TECHNICAL FIELD

The present disclosure relates generally to wireless communication systems and, more specifically, the present disclosure is related to apparatuses and methods for uplink (UL) transmission.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UL transmission.

In one embodiment, a user equipment (UE) is provided. The UE includes a transceiver configured to receive a downlink (DL) reference signal (RS) associated with a channel state information (CSI) report. The UE further includes a processor operably coupled to the transceiver. The processor configured to measure the DL RS and determine an UL channel based on the measurement. The transceiver is further configured to transmit the CSI report including information about the UL channel.

In another embodiment, a BS is provided. The BS includes a transceiver configured to transmit a DL RS associated with a CSI report and receive the CSI report including information about an UL channel. The UL channel is based on measurement of the DL RS.

In yet another embodiment, a method performed by a UE is provided. The method includes receiving a DL RS associated with a CSI report and measuring the DL RS. The method further includes determining an UL channel based on the measurement and transmitting the CSI report including information about the UL channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates example radio access network (RAN) configurations according to embodiments of the present disclosure;

FIG. 7 illustrates example functional split points/options according to embodiments of the present disclosure;

FIG. 8 illustrates an example coverage edge (CE) according to embodiments of the present disclosure;

FIG. 9 illustrates example antenna port layouts according to embodiments of the present disclosure;

FIG. 10 illustrates an example antenna port layouts according to embodiments of the present disclosure;

FIG. 11 illustrates example antenna port layouts according to embodiments of the present disclosure;

FIG. 12 illustrates a flowchart of an example procedure for measuring/estimating UL/DL channel(s) according to embodiments of the present disclosure;

FIG. 13 illustrates a flowchart of an example UE procedure for determining a report quantity according to embodiments of the present disclosure;

FIG. 14 illustrates a signal flow of an example procedure for indicating layer quality according to embodiments of the present disclosure;

FIG. 15 illustrates a flowchart of an example procedure for UL transmission according to embodiments of the present disclosure;

FIG. 16 illustrates a signal flow of an example procedure for UL-related reporting according to embodiments of the present disclosure;

FIG. 17 illustrates an example matrix according to embodiments of the present disclosure;

FIG. 18 illustrates a signal flow of an example procedure for UL-related reporting according to embodiments of the present disclosure;

FIG. 19 illustrates signal flows of example procedures for transmitting UL interference I according to embodiments of the present disclosure;

FIG. 20 illustrates a signal flow of an example procedure for UL-related reporting according to embodiments of the present disclosure;

FIG. 21 illustrates a signal flow of an example procedure for UL-related reporting according to embodiments of the present disclosure;

FIG. 22 illustrates a signal flow of an example procedure for UL-related reporting according to embodiments of the present disclosure;

FIG. 23 illustrates a signal flow of an example procedure for UL-related reporting according to embodiments of the present disclosure;

FIG. 24 illustrates a signal flow of an example procedure for UL-related reporting according to embodiments of the present disclosure;

FIG. 25 illustrates a signal flow of an example procedure for UL-related reporting according to embodiments of the present disclosure;

FIG. 26 illustrates a signal flow of an example procedure for indicating layer quality according to embodiments of the present disclosure;

FIG. 27 illustrates a signal flow of an example procedure for UL-related reporting according to embodiments of the present disclosure;

FIG. 28 illustrates examples of frequency domain (FD) allocations according to embodiments of the present disclosure;

FIGS. 29A and 29B illustrate signal flows of an example procedure for channel state information (CSI) reporting and sounding reference signal (SRS) transmission according to embodiments of the present disclosure;

FIG. 30 illustrates examples triggers for CSI reporting and SRS transmission according to embodiments of the present disclosure; and

FIG. 31 illustrates an example method performed by a UE in a wireless communication system according to embodiments of the present disclosure.

### DETAILED DESCRIPTION

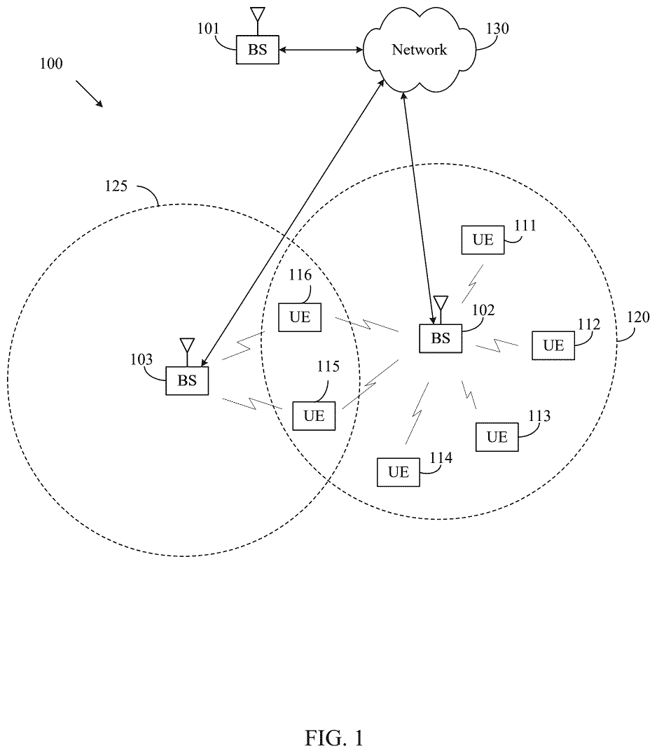

FIGS. 1-31 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 36.211 v17.1.0, “E-UTRA, Physical channels and modulation;” [REF 2] 3GPP TS 36.212 v17.1.0, “E-UTRA, Multiplexing and Channel coding;” [REF 3] 3GPP TS 36.213 v17.1.0, “E-UTRA, Physical Layer Procedures;” [REF 4] 3GPP TS 36.321 v17.1.0, “E-UTRA, Medium Access Control (MAC) protocol specification;” [REF 5] 3GPP TS 36.331 v17.1.0, “E-UTRA, Radio Resource Control (RRC) Protocol Specification;” [REF 6] 3GPP TS 38.331 v18.1.0, “NR, Radio Resource Control (RRC) Protocol Specification;” [REF 7] 3GPP TS 38.212 v18.1.0, “NR, Multiplexing and Channel coding;” [REF 8] 3GPP TS 38.213 v18.1.0, “NR, Physical Layer Procedures for Control;” [REF 9] 3GPP TS 38.214 v18.1.0, “NR, Physical Layer Procedures for Data;” [REF 10] 3GPP TS 38.211 v18.1.0, “NR, Physical channels and modulation;” [REF 11] O-RAN.WG4.CONF.0-R003-v09.00, “O-RAN Working Group 4 (Fronthaul Working Group) Conformance Test Specification;” [REF 12] O-RAN.WG4.CUS.0-R003-v13.00, “O-RAN Working Group 4 (Open Fronthaul Interfaces WG)—Control, User and Synchronization Plane Specification; and [REF 13] 3GPP TS 38.321 v18.1.0, “NR, Medium Access Control (MAC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing UL transmission. In certain embodiments, one or more of the BSs 101-103 include circuitry, programing, or a combination thereof to support UL transmission.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

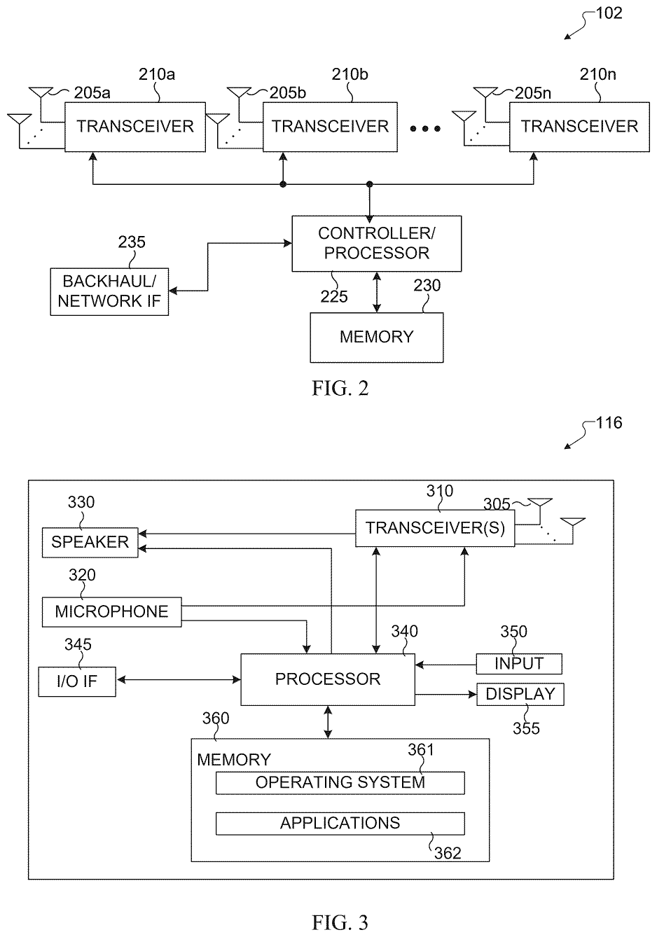

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for UL transmission. Any of a wide variety of other functions could be supported in the gNB 102 by the controller/processor 225.

The controller/processor 225 is also capable of executing programs and other processes resident in the memory 230, such as processes to support UL transmission. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UL transmission as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

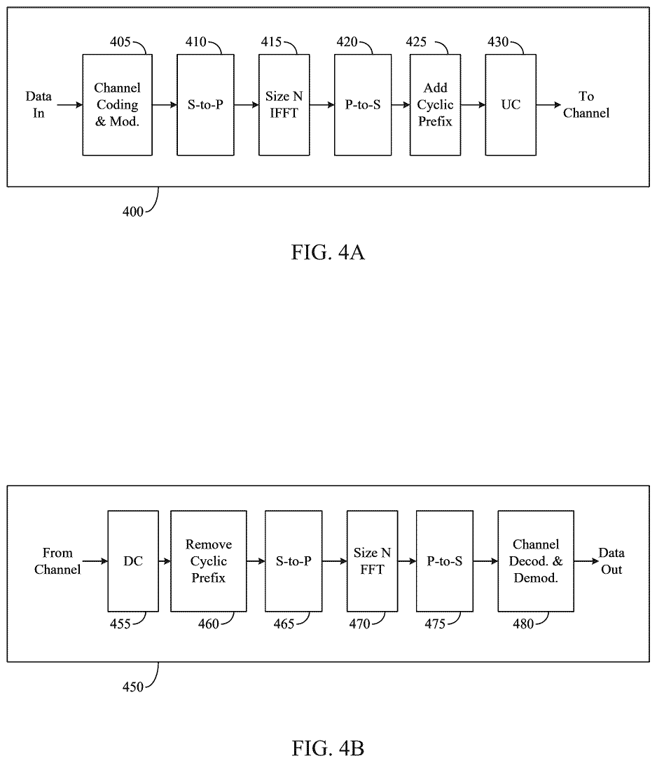

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for UL transmission as described in embodiments of the present disclosure. In some embodiments, the receive path 450 is configured for UL transmission as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

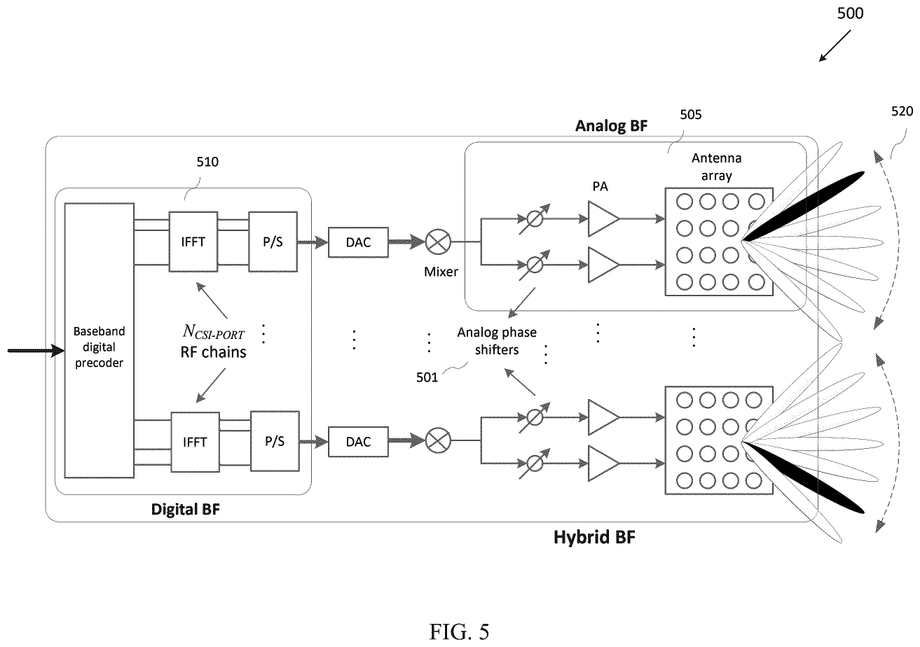

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the 02 absorption loss around 60 GHz frequency (˜10 dB additional loss per 100 m distance), a larger number and narrower analog beams (hence a larger number of radiators in the array) are essential to compensate for the additional path loss.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown in Table 1. Whenever the FR2 is referred, both FR2-1 and FR2-2 frequency sub-ranges are provided, unless otherwise stated.

TABLE 1
Definition of frequency ranges

| | |
|---|---|
| Frequency range designation | Corresponding frequency range |

| FR1 | | 410 MHz-7125 MHz |
|---|---|---|
| FR2 | FR2-1 | 24250 MHz-52600 MHz |
| | FR2-2 | 52600 MHz-71000 MHz |

In next generation cellular standards (e.g. 6G), in addition to FR1 and FR2, new carrier frequency bands can be taken into account, e.g. terahertz (>100 GHz) and FR3 or upper mid-band (7-24 GHz). The number of antenna ports that can be supported for these new bands is likely to be different from FR1 and FR2. In particular, for 7-15 GHz band, the max number of antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs or O-RUs within a cellular region can be the main scenario of interest, due to which the number of CSI-RS antenna ports for MIMO can be even larger (e.g. up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

The 3GPP specification (such as 4G LTE and 5G NR) supports up to 32 CSI-RS antenna ports which enable an eNB (or gNB) to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase. For UL transmission, the 3GPP specification supports 1, 2, or 4 SRS antenna ports in one SRS resource, where each SRS antenna port can be mapped to one or multiple antenna elements at the UE.

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed taking into account carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multi user (MU)-MIMO spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

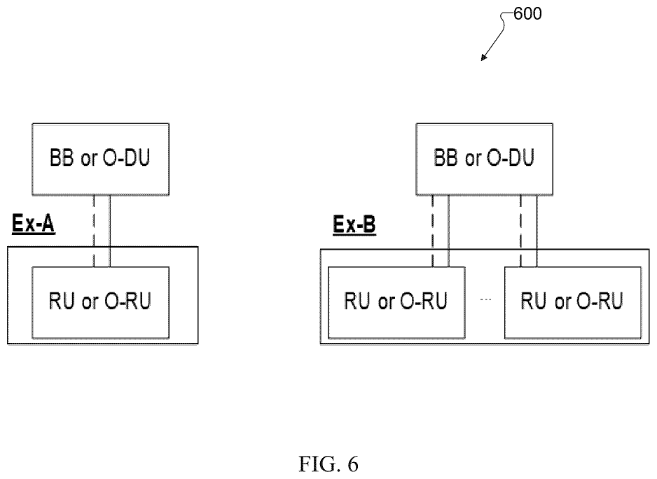

FIG. 6 illustrates example RAN configurations 600 according to embodiments of the present disclosure. For example, RAN configurations 600 can be implemented by the BS 102 of FIG. 1. This example is for illustration only and other embodiments can be used without departing from the scope of the present disclosure.

In an O-RAN NW architecture, a TRP can be functionally equivalent to (hence can be replaced with) or is interchangeable with one of more of the following:
One RU or O-RU: a logical node that includes a subset of the eNB/gNB functions (e.g. as listed in clause 4.2 split option 7-2x)
More than one RUs or O-RUs
One or more than one RUs or O-RUs

Two examples are shown in FIG. 6.

The following are defined in [REF11 and REF12].

| | |
|---|---|
| O-CU | O-RAN Central Unit - a logical node hosting PDCP, RRC, SDAP and other control |
| | functions |
| O-DU | O-RAN Distributed Unit: a logical node hosting RLC/MAC/High-PHY layers based |
| | on a lower layer functional split. O-DU in addition hosts an M-Plane instance. |
| O-RU | O-RAN Radio Unit: a logical node hosting Low-PHY layer and RF processing based |
| | on a lower layer functional split. This is similar to 3GPP's “TRP” or “RRH” but |
| | more specific in including the Low-PHY layer (FFT/iFFT, PRACH extraction). O- |
| | RU in addition hosts M-Plane instance. |

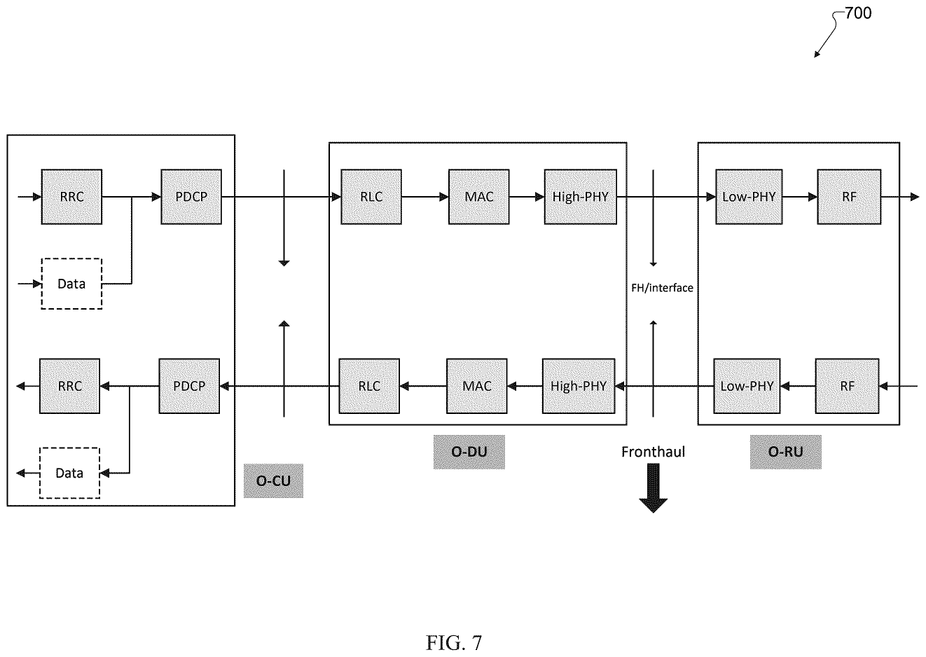

FIG. 7 illustrates example functional split points/options 700 according to embodiments of the present disclosure. For example, functional split points/options 700 may be implemented by the BS 102 of FIG. 1. This example is for illustration only and other embodiments can be used without departing from the scope of the present disclosure.

In next-gen MIMO systems (e.g. 6G), at least two aspects need to be taken into account.
(A) 3GPP PHY specification: The significance of a single NW entity, namely PG (as a collection of ports) in terms of port-common channel properties. This is analogous to the 5G QCL (or transmission configuration indication (TCI) state), coherency assumption (e.g. FC, PC, NC).
(B) NW architecture as perceived in O-RAN: The functionality split among O-RAN entities for DL and UL operations, such as O-RU, O-DU, and O-CU (as described herein). An example is shown in FIG. 7. In particular, the PHY functionality split between O-DU and O-RU includes at least the following aspects.
   (B1) PHY processing:
      bit-level processing,
      symbol-level processing
   (B2) Scheduling (residing in MAC): SU-MIMO/MU-MIMO scheduling across different O-RUs or/and allocated frequency-domain resources (e.g. physical resource blocks (PRBs), precoding resource block groups (PRGs), subbands (SBs))
      Utilizing uplink control information (UCI) carrying CSI
      If DL/UL reciprocity is feasible, also utilizing SRS-based channel measurement
   (B3) Precoder calculation at a gNB (NW side) for DL-SCH transmission:
      For SU-MIMO, precoder can simply follow the PMI (calculated expecting SU-MIMO hypothesis) reported by the UE, or, if DL/UL reciprocity is feasible, be calculated from the eigenvector(s) of the measured DL channels.
      For MU-MIMO, precoder needs to be calculated based on additional orthogonalization (e.g. zero-forcing beamforming (ZFBF), SLNR) among PMIs, or, if DL/UL reciprocity is feasible, the eigenvectors of the measured channels of the co-scheduled UEs

The first (A) can be achieved by removing/merging duplicate/redundant abstractions, and simplifying signaling for components of the abstractions. One such framework, namely dynamic MIMO, is provided in this disclosure, wherein abstractions such as CSI-RS resource, CSI-RS resource set, port, beam, TRP, panel etc. can be clubbed into one basic entity, namely antenna/port group (PG or O-RU (or RU)), and essential features of PGs are specified. A few essential features discussed include dynamic PG or O-RU (or RU) selection and long-term stats and expectations across PGs, e.g., quasi co-location (QCL) and coherency relationships across PGs. The provided framework can also facilitate fast and accurate CSI acquisition, where the CSI can be beam-related (e.g. beam indicator, beam metric), non-beam-related (e.g. rank indicator (RI)/precoding matrix indicator (PMI)/channel quality indicator (CQI)), or both. Additionally, the concept of a cell is replaced with PGs that are distributed through the NW. The mobility can be handled via the PG or O-RU (or RU) selection/update (from one set of PGs to another set of PGs).

A few relevant (more-probable) candidates discussed in the O-RAN Alliance (depicted in FIG. 7) are shown in Table 2.

TABLE 2
(both DL and UL)

| | | | | | | | |
|---|---|---|---|---|---|---|---|
| | | | HI- | LOW- | | | |
| PDCP | RLC | MAC | PHY | PHY | RF | HLS | LLS |

| | | | | | |
|---|---|---|---|---|---|
| O-RAN¹ | O-CU: | O-DU: RLC, MAC, Hi- | O-RU: Low- | Y | symbol-level |
| (Opt7-2x) | PDCP | PHY | PHY, RF | | PHY |
| Opt7-3 | O-CU: | O-DU: RLC, MAC, Hi- | O-RU: Low- | Y | bit-level PHY |
| | PDCP | PHY | PHY, RF | | |

| | | | | |
|---|---|---|---|---|
| Opt8 | DU: RLC, MAC, PHY | RU: | Y | CPRI |

RF

O-RAN¹: [REF 12]
Cat-A, Cat-B
UL: Cat-C

While the O-RAN Alliance is intended for 5G NR, it is expected that its framework will continue, or at most refined, for 6G. The O-RAN Alliance specifies 3 levels of functional splits—namely CU, DU, and RU—to facilitate multi-vendor inter-operability within a NW. The manner in which PHY-layer functions are split between DU and RU(s) imposes serious impact on the feasibility, performance, and complexity of different MIMO schemes—mainly due to the latency and quantization loss incurred by the O-RAN-standardized RU-DU interface.

The present disclosure relates generally to wireless communication systems and, more specifically, to UL transmission.

In NR, two transmission schemes are supported for PUSCH: codebook-based transmission and non-codebook-based transmission. The UE is configured with codebook-based transmission when the higher layer parameter txConfig in pusch-Config is set to ‘codebook’, the UE is configured non-codebook-based transmission when the higher layer parameter txConfig is set to ‘nonCodebook’.

According to Section 6.1.1.1 [REF9], the following is supported for codebook-based UL transmission.

For codebook-based transmission, PUSCH can be scheduled by downlink control information (DCI) format 0_0, DCI format 0_1, DCI format 0_2 or semi-statically configured to operate according to Clause 6.1.2.3 [REF9]. If this PUSCH is scheduled by DCI format 0_1, DCI format 0_2, or semi-statically configured to operate according to Clause 6.1.2.3 [REF9], the UE determines its PUSCH transmission precoder based on SRS resource indicator (SRI), transmit precoding matrix indicator (TPMI) and the transmission rank, where the SRI, TPMI and the transmission rank are given by DCI fields of SRS resource indicator and Precoding information and number of layers in clause 7.3.1.1.2 and 7.3.1.1.3 of [5, REF] for DCI format 0_1 and 0_2 or given by srs-ResourceIndicator and precodingAndNumberOfLayers according to clause 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. Only one SRS resource set can be configured in srs-ResourceSetToAddModList with higher layer parameter usage in SRS-ResourceSet set to ‘codebook’, and only one SRS resource set can be configured in srs-ResourceSetToAddModListDCI-0-2 with higher layer parameter usage in SRS-ResourceSet set to ‘codebook’. The TPMI is used to indicate the precoder to be applied over the layers {0 . . . v−1} and that corresponds to the SRS resource selected by the SRI when multiple SRS resources are configured, or if a single SRS resource is configured TPMI is used to indicate the precoder to be applied over the layers {0 . . . v−1} and that corresponds to the SRS resource. The transmission precoder is selected from the uplink codebook that has a number of antenna ports equal to higher layer parameter nrofSRS-Ports in SRS-Config, as defined in Clause 6.3.1.5 of [4, [REF 10]]. When the UE is configured with the higher layer parameter txConfig set to ‘codebook’, the UE is configured with at least one SRS resource. The indicated SRI in slot n is associated with the most recent transmission of SRS resource identified by the SRI, where the SRS resource is prior to the physical downlink control channel (PDCCH) carrying the SRI.

For codebook based transmission, the UE determines its codebook subsets based on TPMI and upon the reception of higher layer parameter codebookSubset in pusch-Config for PUSCH associated with DCI format 0_1 and codebookSubsetDCI-0-2 in pusch-Config for PUSCH associated with DCI format 0_2 which may be configured with ‘fullyAndPartialAndNonCoherent’, or ‘partialAndNonCoherent’, or ‘nonCoherent’ depending on the UE capability. When higher layer parameter ul-FullPowerTransmission is set to ‘fullpowerMode2’ and the higher layer parameter codebookSubset or the higher layer parameter codebookSubsetForDCI-Format0-2 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

For codebook based transmission, only one SRS resource can be indicated based on the SRI from within the SRS resource set. Except when higher layer parameter ul-FullPowerTransmission is set to ‘fullpowerMode2’, the maximum number of configured SRS resources for codebook based transmission is 2. If aperiodic SRS is configured for a UE, the SRS request field in DCI triggers the transmission of aperiodic SRS resources.

The UE transmits PUSCH using the same antenna port(s) as the SRS port(s) in the SRS resource indicated by the DCI format 0_1 or 0_2 or by configuredGrantConfig according to clause 6.1.2.3.

The DM-RS antenna ports {\tilde{p}₀, . . . , \tilde{p}ᵥ₋₁} in Clause 6.4.1.1.3 of [4, [REF 10]] are determined according to the ordering of DM-RS port(s) given by Tables 7.3.1.1.2-6 to 7.3.1.1.2-23 in Clause 7.3.1.1.2 of [5, [REF 7]].

In the rest of the disclosure, ‘fullAndPartialAndNonCoherent’, ‘partialAndNonCoherent’, and ‘Non-Coherent’ are referred to codebookSubsets depending on three coherence type/capability, where the term ‘coherence’ implies all or a subset of antenna ports at the UE that can be used to transmit a layer coherently. In particular,
the term ‘full-coherence’ (FC) implies antenna ports at the UE that can be used to transmit a layer coherently.
the term ‘partial-coherence’ (PC) implies a subset (at least two but less than all) of antenna ports at the UE that can be used to transmit a layer coherently.
the term ‘non-coherence’ (NC) implies only one antenna port at the UE that can be used to transmit a layer.

When the UE (e.g., the UE 116) is configured with codebookSubset=‘fullAndPartialAndNonCoherent’, the UL codebook includes three types (FC, PC, NC) of precoding matrices; when the UE is configured with codebookSubset=‘partialAndNonCoherent’, the UL codebook includes two types (PC, NC) of precoding matrices; and when the UE is configured with codebookSubset=‘nonCoherent’, the UL codebook includes only one type (NC) of precoding matrices.

According to Section 6.3.1.5 of REF7, for non-codebook-based UL transmission, the precoding matrix W equals the identity matrix. For codebook-based UL transmission, the precoding matrix W is given by W=1 for single-layer transmission on a single antenna port, otherwise by Table 3 to Table 8, which are copied herein.

The rank (or number of layers) and the corresponding precoding matrix W are indicated to the UE using transmission rank indicator (TRI) and TPMI, respectively. In one example, this indication is joint via a field ‘Precoding information and number of layers’ in DCI, e.g., using DCI format 0_1. In another example, this indication is via higher layer RRC signaling. In one example, the mapping between a field ‘Precoding information and number of layers’ and TRI/TPMI is according to Section 7.3.1.1.2 of [REF10].

TABLE 3
Precoding matrix W for single-layer transmission using two antenna ports.

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 4
Precoding matrix W for single-layer transmission using four antenna ports with transform
precoding disabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 5
Precoding matrix W for two-layer transmission using two antenna ports with transform
precoding disabled.

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 6
Precoding matrix W for two-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 7
Precoding matrix W for three-layer transmission using four antenna ports with transform
precoding disabled.

| TPMI | W | | | |
|---|---|---|---|---|
| index | (ordered from left to right in increasing order of TPMI index) W | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 8
Precoding matrix W for four-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

The subset of TPMI indices for the three coherence types are summarized in Table 9 and Table 10, where rank=r corresponds to (and is equivalent to) r layers.

TABLE 9
Total power of precoding matrix W for 2 antenna ports

| | |
|---|---|
| Non-Coherent (NC) | Full-Coherent (FC) |
| TPMIs | TPMIs |

| | TPMI | Total | TPMI | Total |
|---|---|---|---|---|
| Rank | indices | power | indices | power |
| 1 | 0-1 | ½ | 2-5 | 1 |
| 2 | 0 | 1 | 1-2 | 1 |

TABLE 10
Total power of precoding matrix W for 4 antenna ports

| | Non-Coherent | | Partial-Coherent | | Full-Coherent | |
|---|---|---|---|---|---|---|
| | (NC) TPMIs | | (PC) TPMIs | | (FC) TPMIs | |
| | TPMI | Total | TPMI | Total | TPMI | Total |
| Rank | indices | power | indices | power | indices | power |
| 1 | 0-3 | ¼ | 4-11 | ½ | 12-27 | 1 |
| 2 | 0-5 | ½ | 6-13 | 1 | 14-21 | 1 |
| 3 | 0 | ¾ | 1-2 | 1 | 3-6 | 1 |
| 4 | 0 | 1 | 1-2 | 1 | 3-4 | 1 |

The corresponding supported codebookSubsets are summarized in Table 11 and Table 12.

TABLE 11
TPMI indices for codebookSubsets for 2 antenna ports

| Rank | Non-Coherent | fullAndPartialAndNonCoherent |
|---|---|---|
| 1 | 0-1 | 0-5 |
| 2 | 0 | 0-2 |

TABLE 12
TPMI indices for codebookSubsets for 4 antenna ports

| | Non- | partialAndNon- | fullAndPartialAndNon- |
|---|---|---|---|
| Rank | Coherent | Coherent | Coherent |
| 1 | 0-3 | 0-11 | 0-27 |
| 2 | 0-5 | 0-13 | 0-21 |
| 3 | 0 | 0-2 | 0-6 |
| 4 | 0 | 0-2 | 0-4 |

In up to Rel. 17 NR, for UL transmission, the 3GPP specification supports 1, 2, or 4 SRS antenna ports in one SRS resource. In Rel. 18, the number of SRS antenna ports can be 8, targeting devices such as CPE, FWA, and vehicular UEs. For commercial handheld devices (UEs), for example the smart phones in the current market, are generally restricted by 2Tx chains (or antenna ports). Even though 4 Tx chains (or antenna ports) are supported in Rel.15 NR, 4 Tx chains are not likely to be applied in the commercial handheld UEs in the near future due to various commercial factors, including the PA cost and limited size of commercial cell phones. However, the advanced or next/future generation of smartphones are (or likely to be) capable of supporting 3 Tx chains in one same frequency band, if feasible, this can boost the UL throughput significantly. In Rel. 19, UL based on 3 antenna ports is supported.

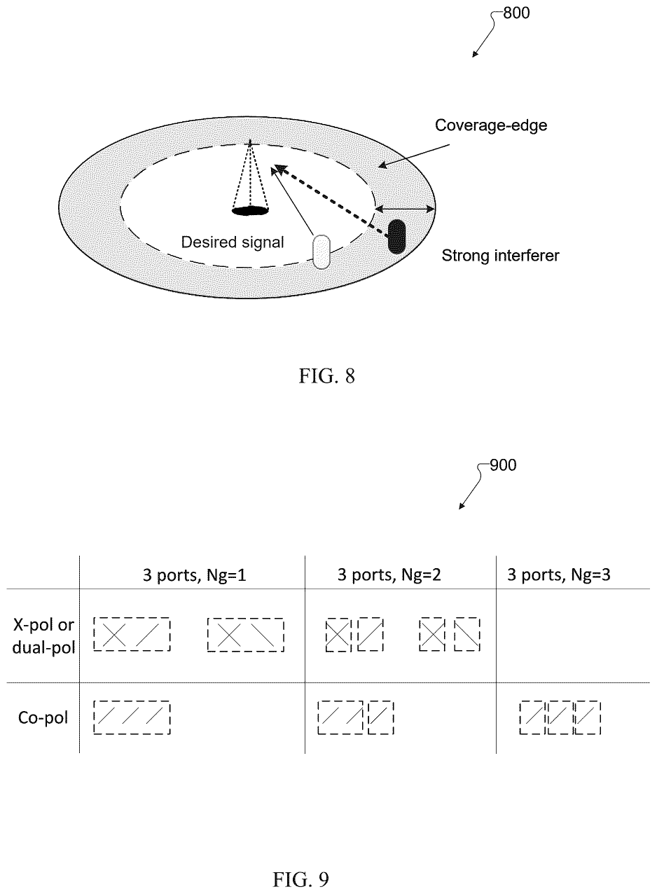

FIG. 8 illustrates an example CE 800 according to embodiments of the present disclosure. For example, CE 800 can be implemented by the BS 103 within the coverage area 125 of FIG. 1. This example is for illustration only and other embodiments can be used without departing from the scope of the present disclosure.

UL performance in coverage/interference-limited scenarios remains a critical issue in 5G deployments. For example, a coverage-edge (CE) UE, as shown in FIG. 8, experiences a significant degradation (e.g. 1/100) in UL performance when compared with a reference (idea) UL performance. The same UE on the hand experiences a moderate degradation (e.g. 1/10) in DL performance. The UL signal-to-interference-plus-noise ratio (SINR)

$$\frac{S}{I + N}$$

is low at coverage-edge, due to strong UL interference (I) and (relative to I) weak desired signal (S). Relying on SRS for (i) determining S is inaccurate/erroneous due to the presence of strong I, but (ii) determining I is perfectly fine (since I is anyway strong). Therefore, alternative methods for acquiring accurate UL signal S in interference-limited scenarios are needed in order to improve the accuracy of UL SINR calculation (thereby improving UL link adaptation).

When 4G and 5G deployments are compared, UL coverage remains a bottleneck in both systems, although 5G DL is significantly better than 4G LTE. Implying, gap between DL and UL performance widens in 5G when compared with 4G. Going into 6G, this gap can widen further if UL coverage issue is not addressed. Therefore, 6G UL MIMO should provide solution(s) to this critical issue. In particular, embodiments of the present disclosure recognize that solution(s) should target scenarios where accurate UL-CSI is unavailable at the gNB (due to poor UL SNR, or when UL interference is high).

This disclosure provides several example UL MIMO schemes exploiting UL-DL reciprocity, where DL RS (e.g. CSI-RS) is utilized by the UE to provide UL-CSI estimation for time division duplexing (TDD) scenarios. The schemes exploit the fact that unlike UL RS, e.g. SRS (which has accuracy issues due to poor UL coverage), DL RS (e.g. CSI-RS) doesn't suffer from the same interference issue for signal S measurement. Thus, the solution can be based on the use of CSI-RS for signal S measurement (included in a UE report) and the use of SRS for interference I measurement at the NW.

The scope of the disclosure is not limited to embodiments or examples therein, but includes their extensions or combinations. Besides, example schemes or solutions provided in this disclosure can also be used for DL, or sidelink (SL).

The present disclosure relates to reciprocity-based UL transmission. Embodiments of the present disclosure include:
UL link adaption (modulation and coding scheme (MCS) selection) based on UL SINR calculation in which the signal part is based on DL RS (e.g. NZP CSI-RS) measured at the UE, and the interference part is measured at the NW/gNB;
Schemes wherein the signal part is reported by the UE, and NW/gNB calculates UL SINR;
Schemes wherein the interference part is indicated to the UE, and UE calculates UL SINR or UL CQI or UL MCS, and reports it to the NW/gNB for UL link adaptation; and
Signaling details.

In the following, for brevity, both frequency division duplexing (FDD) and time division duplexing (TDD) are regarded as the duplex method for both DL and UL signaling.

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

FIG. 9 illustrates example antenna port layouts 900 according to embodiments of the present disclosure. For example, antenna port layouts 900 can be implemented by any of the UEs 111-116 of FIG. 1, such as the UE 111. This example is for illustration only and other embodiments can be used without departing from the scope of the present disclosure.

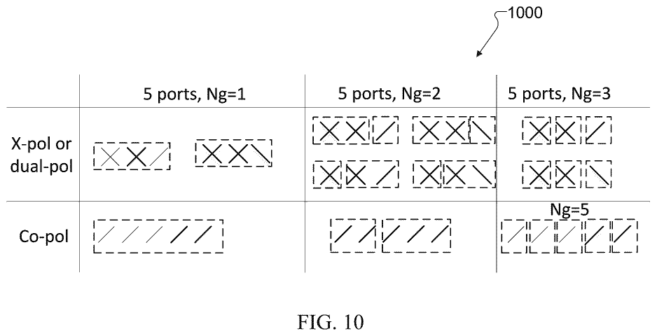

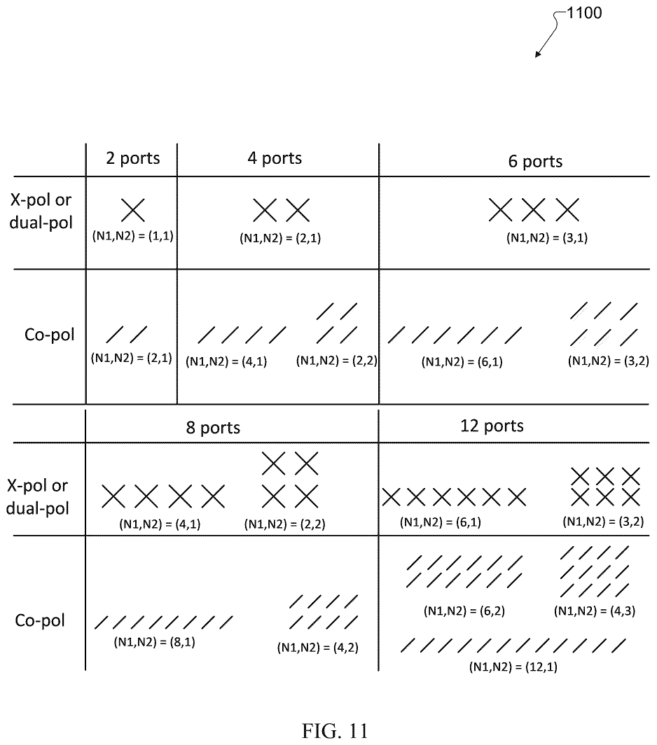

FIG. 10 illustrates an example antenna port layouts 1000 according to embodiments of the present disclosure. For example, antenna port layouts 1000 can be implemented by any of the UEs 111-116 of FIG. 1, such as the UE 112. This example is for illustration only and other embodiments can be used without departing from the scope of the present disclosure.

FIG. 11 illustrates example antenna port layouts 1100 according to embodiments of the present disclosure. For example, antenna port layouts 1100 can be implemented by any of the UEs 111-116 of FIG. 1, such as the UE 113. This example is for illustration only and other embodiments can be used without departing from the scope of the present disclosure.

In this disclosure, a UE with even/odd number of antenna ports is provided. Antenna ports of the UE can belong to a single antenna panel or group (i.e., they are co-located, for example, at one plane, side, or edge of the UE) or multiple antenna panels or groups. For a given antenna panel or group, N₁ and N₂ are the number of antenna ports with the same polarization in the first and second dimensions, respectively. For 2D antenna port layouts, N₁>1, N₂>1, and for 1D antenna port layouts, N₁>1 and N₂=1 or N₂>1 and N₁=1. In the rest of the disclosure, 1D antenna port layouts with N₁>1 and N₂=1 is provided. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ applies to the case N₁<N₂ by swapping/switching (N₁, N₂) with (N₂, N₁). For a given antenna panel or group, when a (single-polarized) co-polarized antenna port layout, the total number of antenna ports is P=N₁N₂ and when a dual-polarized antenna port layout, the total number of antenna ports is P=2N₁N₂. When the UE (e.g., the UE 116) has P=3 antenna ports, an illustration of antenna port layouts is shown in FIG. 9. An illustration of antenna port layouts for {2, 4, 6, 8, 12} antenna ports at UE is shown in FIG. 11.

Let N_{g} be the number of antenna port groups (panels). For a co-polarized (single polarized) case,
N_{g}=1: one group comprising antenna ports,
N_{g}=2: two groups, one comprising P₁ antenna ports, and another comprising P₂=P−P₁ antenna ports, and

N_{g}=P: P groups, each comprising 1 antenna port.

For a dual-polarized (cross-polarized) case,
N_{g}=1: one group comprising

$$X = ⌊ \frac{P}{2} ⌋$$

cross-pol antenna ports, and P−X single-pol antenna port(s).
N_{g}=2: two groups, one comprising

$${P}_{1} = a ⌊ \frac{P}{2} ⌋$$

cross-pol antenna ports where a∈{1, 2, . . . }, and another comprising P₂=P−P₁ single-pol antenna port.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P=sN₁N₂. In one example, the antenna ports at the UE refers to SRS antenna ports (either in one SRS resource or across multiple SRS resources).

The UL codebook W for P antenna ports at the UE is based on pre-coding vectors, which can have a structure according to one of the examples in Table 13 depending on whether P if even or odd, and whether the antenna ports are co-polarized or a combination of co-polarized and cross-/dual-polarized.
Ex1A: corresponds to N_{g}=1 with co-polarized ports.
Ex1B: corresponds to N_{g}=1 with dual-polarized ports.
Ex2: corresponds to N_{g}=2, 1D antenna layout, P=Pₓ+P_{co} with Pₓ cross-pol ports and P_{co} co-polarized ports.

Ex3: corresponds to N_{g}=2, 2D antenna layout, Pₓ=2N_{x,1}N_{x,2} and P_{co}=N_{co,1}N_{co,2} with Pₓ cross-pol ports and P_{co} co-polarized ports.

TABLE 13
Pre-coding vectors

| | | P is odd | |
|---|---|---|---|
| Ex1A: | | Ex2: Co-pol + Dual-pol | Ex3: Co-pol + Dual-pol |
| Co-pol | Ex1B: Dual-pol | (1D) | (2D) |
| $W = \frac{{w}_{l}}{\sqrt{P}}$ | $W = \frac{1}{\sqrt{P}} {w}_{cross - pol}$ | $W = \frac{1}{\sqrt{P}} [ \begin{matrix}{w}_{cross - pol} \\ {w}_{co - pol}\end{matrix} ] or$ | $W = \frac{1}{\sqrt{P}} [ \begin{matrix}{w}_{cross - pol} \\ {w}_{co - pol}\end{matrix} ] or$ |
| | ${w}_{cross - pol} = {v}_{l , n} = [ \begin{matrix}{w}_{l} \\ {φ}_{n} {w}_{l}\end{matrix} ]$ | $\frac{1}{\sqrt{P}} [ \begin{matrix}{w}_{co - pol} \\ {w}_{cross - pol}\end{matrix} ]$ | $\frac{1}{\sqrt{P}} [ \begin{matrix}{w}_{co - pol} \\ {w}_{cross - pol}\end{matrix} ]$ |
| | ${w}_{cross - pol} = {v}_{l , m , n} = [ \begin{matrix}{v}_{l , m} \\ {φ}_{n} {v}_{l , m}\end{matrix} ]$ | ${w}_{cross - pol} = {v}_{{l}_{1} , n} = [ \begin{matrix}{w}_{{l}_{1}} \\ {φ}_{n} {w}_{{l}_{1}}\end{matrix} ]$ | ${w}_{cross - pol} = {v}_{{l}_{1} , m , n} = [ \begin{matrix}{v}_{{l}_{1} , m} \\ {φ}_{n} {v}_{{l}_{1} , m}\end{matrix} ]$ |
| | | W_{co-pol} = Wₗ_{₂} | W_{co-pol} = Vₗ_{₂}_{, m}_{₂} |

Here, v_{l,m} is a Kronecker product (⊗) of vectors wₗ and uₘ of lengths N₁ and N₂, respectively. In one example, wₗ and uₘ are oversampled DFT vectors, i.e.,

$${w}_{l} = [ \begin{matrix}1 & {e}^{j \frac{2 π l}{{O}_{1} {N}_{1}}} & {e}^{j \frac{4 π l}{{O}_{1} {N}_{1}}} & … & {e}^{{j \frac{2 π l ( {N}_{1} - 1 )}{{O}_{1} {N}_{1}} ]}^{T}}\end{matrix}$$

$${u}_{m} = \{ \begin{matrix}\begin{matrix}\begin{matrix}\begin{matrix}[ 1 & {e}^{j \frac{2 π m}{{O}_{2} {N}_{2}}} & … & {e}^{j \frac{2 π m ( {N}_{2} − 1 )}{{O}_{2} {N}_{2}}} ]\end{matrix}\end{matrix} & \end{matrix} & {N}_{2} > 1 \\ 1 & {N}_{2} = 1\end{matrix}$$

where O₁ and O₂ are oversampling factors in two dimensions, and v_{l,m} is then given by

$${v}_{l , m} = {w}_{l} ⊗ {u}_{m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T}$$

In one example, both O₁, O₂∈{1,2,4,8}. In one example, O₁ and O₂ can take the same values as Rel.15 NR Type I codebook (cf. 5.2.2.2.1, [REF 9]), i.e., (O₁, O₂)=(4,4) when N₂>1, and, i.e., (O₁, O₂)=(4,1) when N₂=1. Alternatively, they take different values from the Rel. 15 Type I NR codebook, for example, (O₁, O₂)=(2,2) when N₂>1, and, i.e., (O₁, O₂)=(2,1) when N₂=1. In one example, O₁ and O₂ is configurable (e.g. via higher layer). In one example, (O₁, O₂)=(1,1).

The quantity φₙ is a co-phase for dual-polarized antenna port layouts. In one example, φₙ=e^{jπn/2}, where n∈{0,1,2,3} implying that φₙ belongs to QPSK alphabet {1,j,−1,−j}. In one example, φₙ=e^{j2πn/Z}, where n∈{0, 1, 2, . . . Z−1} implying that on belongs to Z-PSK alphabet.

In one example, the values of N₁ and N₂ are configured, e.g. with the higher layer parameter. A few examples of (N₁, N₂) for a given number of antenna ports (P) and antenna layout (co-pol or/and cross-pol) is given in Table 14. The notation N_{a,b} where a∈{co,x} and b∈{1,2} is used to denote a number of a-polarized antenna ports in the b-th dimension, respectively.

TABLE 14
Configurations of (N₁, N₂)

| Number of | | | Co-Pol + Dual-pol |
|---|---|---|---|
| antenna | Co-pol | Dual-pol | {(N_{co, 1}, N_{co, 2}), |
| ports, P | (N_{co, 1}, N_{co, 2}) | (N_{x, 1}, N_{x, 2}) | (N_{x, 1}, N_{x, 2})} |
| 1 | (1, 1) | | |
| 2 | (2, 1), (1, 2) | (1, 1) | |
| 3 | (3, 1), (1, 3) | | {(1, 1), (1, 1)} |
| 4 | (4, 1), (1, 4), | (2, 1) | {(2, 1), (1, 1)} |
| | (2, 2) | | {(1, 2), (1, 1)} |
| 5 | (5, 1), (1, 5) | | {(3, 1), (1, 1)} |
| | | | {(1, 3), (1, 1)} |
| | | | {(1, 1), (2, 1)} |
| 6 | (2, 3), (3, 2), | (3, 1) | {(4, 1), (1, 1)} |
| | (6, 1), (1, 6) | | {(1, 4), (1, 1)} |
| | | | {(2, 2), (1, 1)} |
| | | | {(2, 1), (2, 1)} |
| | | | {(1, 2), (2, 1)} |
| 7 | (7, 1), (1, 7) | | {(5, 1), (1, 1)} |
| | | | {(1, 5), (1, 1)} |
| | | | {(3, 1), (2, 1)} |
| | | | {(1, 3), (2, 1)} |
| | | | {(1, 1), (3, 1)} |
| 8 | (8, 1), (1, 8), | (2, 2), (4, 1) | |
| | (4, 2), (2, 4) | | |
| 12 | (3, 2), (6, 1) | (4, 3), (6, 2), (12, 1) | |
| 16 | (4, 2), (8, 1) | (8, 2), (4, 4), (16, 1) | |

In one example, the values of N₁ and N₂ are fixed for a given number of antenna ports. For example, (N₁,N₂)=(P,1) for co-pol and

$$( \frac{P}{2} , 1 )$$

for dual-pol antenna. In one example, only one (N₁,N₂) is supported for each value of P, where the supported (N₁,N₂) is one of pairs in Table 14.

In one example, P antenna ports can be divided into N_{g}∈{1, 2, . . . } groups. In one example, each group corresponds to an antenna panel.

In one example, N_{g}=1 corresponds to a single antenna panel. In one example, N_{g}=1 corresponds to a full coherent (FC) UE or FC antenna layout.

In one example, when number of ports in a group is more than one and N_{g}>1, then ports within each group are coherent, whereas ports across two groups are non-coherent (NC). Such antenna port layout can be referred to as a partial coherent (PC) UE or PC antenna layout.

In one example, N_{g}=P corresponds to a non-coherent (NC) UE or NC antenna layout.

In one example, a single-layer (rank 1) UL transmission can be configured to a UE for both cases when transform precoding is enabled (DFT-s-OFDM) or disabled (CP-OFDM).

Let N_{UL} be the number of antenna ports (or number of Tx RF chains associated with UL transmission) at the UE. Let N_{DL} be the number of antenna ports at the gNB (NW). Let H be the DL channel matrix of size N_{UL}×N_{DL} that can be estimated based on a DL RS (e.g. CSI-RS) measurement. When the DL and UL channels are reciprocal (e.g. TDD), then the UL channel matrix can be estimated (based on the DL RS measurement) as H* and has size N_{DL}×N_{UL}. For brevity of notation, the SB index f or subcarrier index k or polarization index p is not included as suffix or prefix on H. However, in general, H=H^{(I)}, where (I) belongs to {(f,r,p),(f,r),(f,p),(f)} to represent one of four types of channel notations herein. In case of SB comprising of multiple subcarriers, is used to denote

$${H}_{k}^{( I )}$$

is used to denote the channel for subcarrier k in SB f.

Let H^{(f,r,p)} be the channel associated with the f-th SB, r-th antenna at the UE, and p-th polarization at the gNB. Note that H^{(f,r,p)} is a vector of size

$$\frac{{N}_{D L}}{2}$$

when p∈{0,1} (i.e. dual-polarized antenna ports at the gNB).

Let H^{(f,r)} be the channel associated with the f-th SB, r-th antenna at the UE, and antenna ports at the gNB. Note that H^{(f,r)} is a vector of size N_{DL}.

Let H^{(f,p)} be the channel associated with the f-th SB, antenna ports at the UE, and p-th polarization at the gNB. Note that H^{(f,p)} is a matrix of size

$${N}_{UL} \times \frac{{N}_{DL}}{2}$$

when p∈{0,1}.

Let H^{(f)} be the channel associated with the f-th SB, antenna ports at the UE, and antenna ports at the gNB.

The superscript ( )^{H} denotes conjugate transpose, and the superscript ( )^{T} denotes transpose.

For DL channel H, let us define the following:
DEF0: the DL channel is represented using singular value decomposition (SVD) as

$$H \approx {\sum }_{l = 1}^{L} {λ}_{l} {v}_{l} {u}_{l}^{H}$$

where λₗ is a singular value (a non-negative number), vₗ is a left singular vector of length N_{UL} and uₗ is a right singular vector of length N_{DL}. Note that L singular vector pairs (uₗ,vₗ) are provided.
DEF1: Left (UL) covariance matrix is represented as E_{UL}=HH^{H}. For multiple subcarriers,

$${E}_{UL} = \frac{1}{\vert f \vert} {\sum }_{k ∈ f} ( ( {H}_{k} ) {( {H}_{k} )}^{H} ) .$$

DEF2: Right (DL) covariance matrix is represented as E_{DL}=H^{H}H. For multiple subcarriers,

$${E}_{DL} = \frac{1}{\vert f \vert} {\sum }_{k ∈ f} ( {( {H}_{k} )}^{H} ( {H}_{k} ) ) .$$

DEF3: Left (UL) eigenvectors vₗ are derived using Eigen value decomposition (EVD) of the covariance matrix E_{UL} as

$${E}_{UL} = {\sum }_{l = 1}^{{L}_{UL}} {λ}_{UL , l} {v}_{l} {v}_{l}^{H} ,$$

where λ_{UL,l} is an eigenvalue (a non-negative number).
DEF4: Right (DL) eigenvectors uₗ are derived using EVD of the covariance matrix E_{DL} as

$${E}_{DL} = {\sum }_{l = 1}^{{L}_{DL}} {λ}_{DL , l} {u}_{l} {u}_{l}^{H} ,$$

where λ_{DL,l} is an eigenvalue (a non-negative number).

Note L_{UL}=L_{DL}=υ is the rank of the DL or UL covariance matrix and λ_{UL,l}=λ_{DL,l}=λₗ² is an eigenvalue or \sqrt{λ_{UL,l}}=\sqrt{λ_{DL,l}}=λₗ is a corresponding singular value.

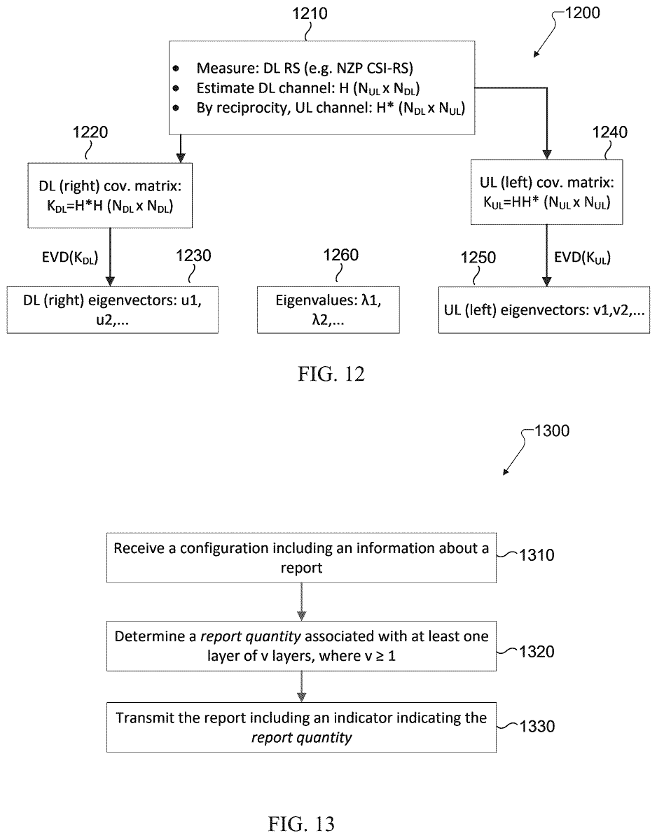

FIG. 12 illustrates a flowchart of an example procedure 1200 for measuring/estimating UL/DL channel(s) according to embodiments of the present disclosure. For example, procedure 1200 can be performed by the UE 116 of FIG. 3. This example is for illustration only and other embodiments can be used without departing from the scope of the present disclosure.

The procedure begins in 1210, a UE measures the DL RS, estimates the DL channel H (N_{UL}×N_{DL}), and by reciprocity estimates the UL channel H*(N_{UL}×N_{DL}). In 1220, the UE determines DL (right) cov. Matrix: K_{DL}=H*H(N_{DL}×N_{DL}). In 1230, the UE determines DL (right) eigenvectors u₁, u₂, . . . . In 1240, the UE determines UL (left) cov. Matrix: K_{UL}=HH*(N_{UL}×N_{UL}). In 1250, the UE determines UL (left) eigenvectors v₁, v₂, . . . . In 1260, the UE determines Eigenvalues λ₁, λ₂, . . . .

In one embodiment, as shown in FIG. 12, a UE is configured to receive a DL RS (e.g. NZP CSI-RS) for measurement, and in response, the UE measures the DL RS, estimates the DL channel H based on the measurement, and assuming DL and UL channel reciprocity estimates UL channel as H^{H} (Hermitian or conjugate transpose of matrix H). As described herein, based on the DL channel H, the UE can also determine the following:
DL (right or transmit) eigenvectors u₁, u₂, . . .
UL (left or receive) eigenvectors v₁, v₂, . . .
Eigenvalues λ₁, λ₂, . . .

Based on DL and UL channel reciprocity, based on the UL channel HH, the UE can also determine the following:
DL (left or receive) eigenvectors u₁, u₂, . . .
UL (right or transmit) eigenvectors v₁, v₂, . . .
Eigenvalues λ₁, λ₂, . . .

Since right or transmit eigenvectors can be used to pre-code,
for DL precoding, eigenvectors u₁, u₂, . . . can be used, and
for UL precoding, eigenvectors v₁, v₂, . . . can be used.

Note that the strength or quality of a l-th DL or UL layer can be determined based on the corresponding value λₗ.

FIG. 13 illustrates a flowchart of an example UE procedure 1300 for determining a report quantity according to embodiments of the present disclosure. For example, procedure 1300 can be performed by any of the UEs 111-116 of FIG. 1, such as the UE 114. This example is for illustration only and other embodiments can be used without departing from the scope of the present disclosure.

The procedure begins in 1310, a UE receives a configuration including an information about a report. In 1320, the UE determines a report quantity associated with at least one layer of v layers, where v≥1. In 1330, the UE transmits the report including an indicator indicating the report quantity.

In one embodiment, as shown in FIG. 13, a UE receives a configuration or/and an indication (e.g. an RRC message, IE, or parameter, or/and a DCI trigger or codepoint) and in response, determines a report quantity associated with at least one layer of a total of v≥1 layers, where the report includes an indicator indicating the determined report quantity, denoted herein as q. The quantity q provides an information about the strength/quality of the at least one layer.

In one example, the report quantity is UL-related. In one example, the report quantity is DL-related. In one example, the report quantity is both DL-related and UL-related.

When DL-related, the report quantity can be associated with a precoding matrix, and a layer corresponds to a column of the precoding matrix, indicated via the PMI or determined by the UE. The PMI can be included in the CSI report (including RI, CQI, PMI, as described in this disclosure). The quantity q therefore can provide information about the strength/quality of layers corresponding to columns of the precoding matrix.

When UL-related, the report quantity can be associated with an UL precoding matrix, and a layer corresponds to a column of the UL precoding matrix, indicated via the TPMI or determined by the UE. The TPMI can be included in the UL-grant. The quantity q therefore can provide information about the strength/quality of layers corresponding to columns of the UL precoding matrix.

The NW/gNB, upon reception, can utilize the UL-related quantity q to improve/adapt/determine UL link adaptation (e.g. UL SNR or SINR for UL MCS selection) for an upcoming UL transmission (e.g. UL-grant for PUSCH transmission).

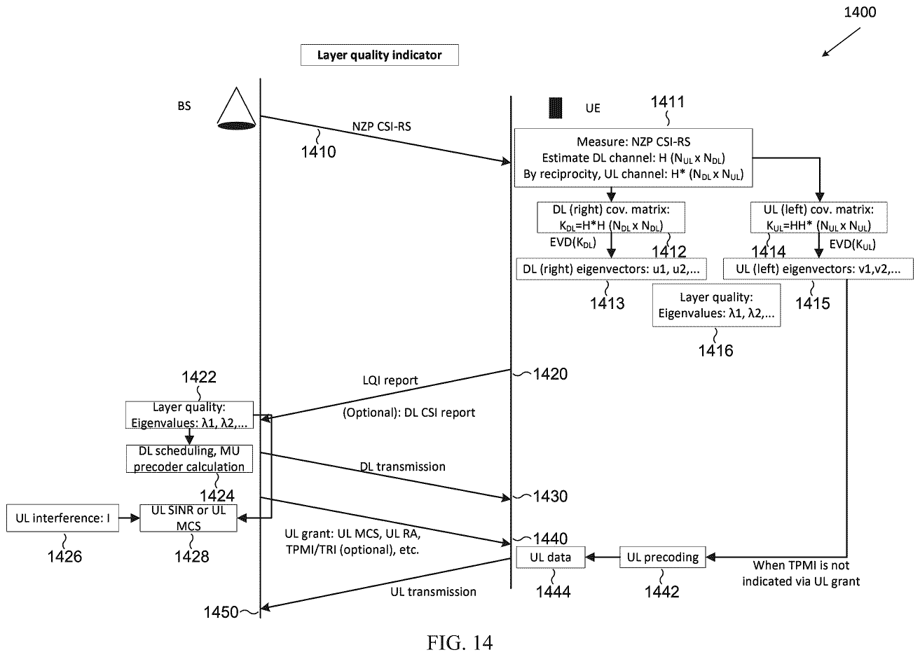

FIG. 14 illustrates a signal flow of an example procedure 1400 for indicating layer quality according to embodiments of the present disclosure. For example, procedure 1400 can be performed by the UE 116 and the gNB 102 and/or network 130 in the wireless network 100 of FIG. 1. This example is for illustration only and other embodiments can be used without departing from the scope of the present disclosure.

The procedure begins in 1410, a BS transmits a NZP CSI-RS to a UE. In 1411, the UE measures NZP CSI-RS, estimates the DL channel H (N_{UL}×N_{DL}), and by reciprocity estimates the UL channel H*(N_{UL}×N_{DL}). In 1412, the UE determines DL (right) cov. Matrix: K_{DL}=H*H (N_{DL}×N_{DL}). In 1413, the UE determines DL (right) eigenvectors u₁, u₂, . . . . In 1414, the UE determines UL (left) cov. Matrix: K_{UL}=HH*(N_{UL}×N_{UL}). In 1415, the UE determines UL (left) eigenvectors v₁, v₂, . . . . In 1416, the UE determines layer quality: Eigenvalues λ₁, λ₂, . . . . In 1420, the UE transmits a layer quality indicator (LQI) report and a (optional) DL CSI report. In 1422, the BS is provided layer quality: Eigenvalues λ₁, λ₂, . . . . In 1424, the BS performs DL scheduling MU precoder calculation. In 1426, the BS provides UL interference: I. In 1428, the BS provides UL SINR or UL MCS. In 1430, the BS transmits a DL transmission to the UE. In 1440, the BS transmits an UL grant: UL MCS, UL RA, transmit precoding matrix indicator (TPMI)/transmission rank indicator (TRI) (optional), etc. to the UE. When TPMI is not indicated via UL grant, in 1442, the UE performs UL precoding. In 1444, the UE provides UL data. In 1450, the UE transmits an UL transmission to the BS.

When DL and UL channels are reciprocal (e.g. in TDD scenarios), the report quantity can be for both DL-related and UL-related. This is due to the fact that the layer quality/strength of a layer can be applied to (or associated with) either a DL layer or a corresponding UL layer. An illustration of utilizing layer quality report for the two use cases (mentioned herein) is shown in FIG. 14. As shown, the UE based on the DL RS measurement can determine DL (right) and UL (left) eigenvectors and corresponding eigenvalues {(u₁, v₁, λₗ)}, report LQI indicating (quantized) eigenvalues {λₗ} or an information about them. The UE can also include DL CSI (e.g. RI, CQI, PMI) in the report. NW/gNB (e.g., the network 130/the BS 102) upon receiving the LQI can determine the layer quality, and apply/utilize it for (a) DL scheduling or/and MU precoding calculation for subsequent DL transmission(s), or (b) UL MCS selection to be indicated via an UL-grant for subsequent UL transmission(s). The UL-grant includes UL resource allocation (UL RA), and may optionally include at least one of UL rank (TRI) and UL precoding (TPMI). When TPMI is not included in the UL-grant, the UE can use the determined UL (left) eigenvectors {vₗ} for UL precoding. When TRI is not included in the UL-grant, the UL rank can be fixed (e.g. 1), or configured via higher layer (e.g. via PUSCH-Config).

In the rest of the disclosure, embodiments and examples are described for schemes utilizing the (UL-related) report quantity for UL transmissions in TDD scenarios (wherein DL-UL reciprocity applies).

In the following, an UL SINR can be defined as:

$$SINR = \frac{S}{1 + N} or as SINR = {\sum }_{k ∈ X} \frac{S ( k )}{I ( k ) + N ( k )}$$

where X is a set of subcarriers.

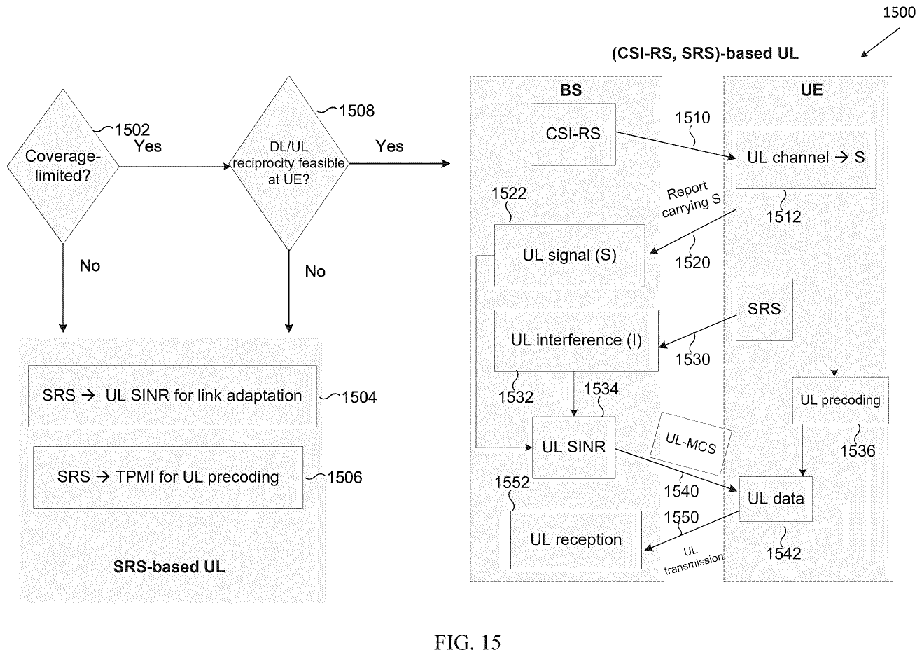

FIG. 15 illustrates a flowchart of an example procedure 1500 for UL transmission according to embodiments of the present disclosure. For example, procedure 1500 can be performed by the UE 111 and the gNB 102 and/or network 130 in the wireless network 100 of FIG. 1. This example is for illustration only and other embodiments can be used without departing from the scope of the present disclosure.

The procedure begins in 1502, a BS determines whether a UE has limited coverage. When the BS determines that the UE does not have limited coverage, then in 1504, SRS is used for UL SINR link adaptation. In 1506, SRS is used for TPMI for UL precoding. When the BS determines that the UE does have limited coverage, then in 1508, the BS determines whether DL/UL reciprocity is feasible at the UE. When the BS determines that DL/UL reciprocity is not feasible at the UE, then 1504 and 1506 are performed. When the BS determines that DL/UL reciprocity is feasible at the UE, then in 1510, the BS transmits CSI-RS to the UE. In 1512, UL channel→S. IN 1520, the UE transmits a report carrying S to the BS. In 1522, the BS determines UL signal (S). In 1530, the UE transmits SRS to the BS. In 1532, the BS determines UL interference (I). In 1534, the BS determines UL SINR. In 1536, the UE may determine/perform UL precoding. In 1540, the BS transmits UL-MCS to the UE. IN 1542, the UE determines UL data. In 1550, the UE transmits UL transmission to the BS. In 1552, the BS receives UL reception.

In one embodiment, as shown in FIG. 15, an UL transmission scheme can be described as follows. When a UE is in coverage, the UL transmission is based on SRS akin to the SRS-based UL transmission scheme (where SRS is used for UL SINR as well as UL TPMI). This scheme can be referred to as Mode 1. Else, when the UE is located in coverage-limited/-edge region and the DL-UL reciprocity is feasible, the UL transmission is SRS-free (NZP CSI-RS instead of SRS is used for UL precoding/TPMI as well as for the signal part of UL SINR). This scheme can be referred to as Mode 2. In Mode 2, the UE (e.g., the UE 116) is configured with an UL-assisting/-related report, wherein the UE is configured with at least one NZP CSI-RS for acquiring/measuring UL CSI based on DL CSI (measured via the at least one NZP CSI-RS). The UL CSI provides an accurate S (in coverage-limited scenarios). The UE based on the measurement, determines a report. In one example, the report is low-res and includes at least one indicator indicating S. In one example, the report is high-res and includes at least one indicator indicating the direct or explicit channel feedback (per FD unit, e.g., SB). The NW performs UL link adaptation for the UE based on the report and (SRS-based or IMR-based) estimated interference I where the SRS or IMR is zero-power (ZP).

In one example, the report is a high-res report wherein the report corresponds to a direct DL channel explicit feedback (per sub-band) based on 5G Rel-16/19 Type-II CSI (L>1), or AI-based direct DL channel feedback (per SB). In one example, the report is a low-res report wherein the report corresponds to an L1-RSRP (per sub-band) based on enhanced L1-RSRP (per SB), or 5G Rel-19 Type-I Scheme-B CSI (L=1).

In one example, the two modes (Mode 1, Mode 2) for the UL transmission scheme are supported for PUSCH: namely, (i) SRS-based, codebook-based transmission and (ii) SRS-free, codebook-based transmission. The UE is configured with SRS-based, codebook-based transmission when the higher layer parameter txConfig in pusch-Config is set to ‘Mode1’ or ‘SRS-based’ or ‘SRS-based-Codebook-based’, or the UE is configured with SRS-free, codebook-based transmission when the higher layer parameter txConfig is set to ‘Mode2’ or ‘SRS-free’ or ‘SRS-free-Codebook-based’. This configuration can be dependent on the UE capability reported by the UE as part of its capability reporting.

In one example, both Mode 1 and Mode 2 are mandatory, i.e., a UE supporting codebook-based UL transmission is required to support both Mode 1 and Mode 2.

In one example, Mode 1 is mandatory, and Mode 2 is optional, i.e., a UE supporting codebook-based UL transmission is required to support Mode 1 and can optionally support Mode 2, the information about which is reported by the UE via a separate or a joint (via a component) UE capability report.

In one example, Mode 2 is mandatory, and Mode 1 is optional, i.e., a UE supporting codebook-based UL transmission is required to support Mode 2 and can optionally support Mode 1, the information about which is reported by the UE via a separate or a joint (via a component) UE capability report.

In one example, both Mode 1 and Mode 2 are optional, i.e., a UE supporting codebook-based UL transmission can optionally support one of or both of Mode 1 and Mode 2, the information about which is reported by the UE via a separate or a joint (via a component) UE capability report. In one example, the information indicates a value from {Mode 1, Mode 2, (Mode 1, Mode 2)}.
In one example, there is one joint capability report indicating a value from {Mode 1, Mode 2, (Mode 1, Mode 2)}, i.e., Report=a value from {Mode 1, Mode 2, (Mode 1, Mode 2)}.
In one example, there are two separate capability reports, one for Mode 1 and one for Mode 2. They can be two components of a capability report, or two respective separate capability reports.
   In one example, Report={Component 1, Component 2}, where Component 1=a value from {NULL, Mode 1}; Component 2=a value from {NULL, Mode 2}.
   In one example, Report 1 can include Mode 1 and Report 2 can include Mode 2.

In one example, a UE can be configured with Mode 2 only when the UE can support UE-side DL-UL reciprocity. The UE provides/reports this information (that the UE can support UE-side DL-UL reciprocity) via a UE capability reporting.
In one example, Mode 2 is mandatory, when the UE can support UE-side DL-UL reciprocity.
In one example, Mode 2 is optional, even when the UE can support UE-side DL-UL reciprocity. That is, a UE can be configured with Mode 2 only when the UE reports being capable of supporting Mode 2 via a separate or a joint (via a component) UE capability report.

In one example, a UE can be configured to report its capability of supporting (UE-side) DL-UL reciprocity. This configuration and reporting can be subject to a time-domain duplexing (TDD) scenario. This reporting can be according to at least one of the following forms.
In one example, the UE capability includes a value from {No, Yes} or {support, do not support}.
In one example, supporting (UE-side) DL-UL reciprocity is conditioned on DL-UL phase offset (difference) being PO≤t, where t is a certain phase value or threshold. The value t can be fixed. The value t can be configured. The value t itself can be a part of the UE capability report, i.e. the UE reports a value of t from a set of candidate values for t.
In one example, supporting (UE-side) DL-UL reciprocity is conditioned on DL-UL phase offset (difference) being PO<t, where t is a certain phase value or threshold. The value t can be fixed. The value t can be configured. The value t itself can be a part of the UE capability report, i.e. the UE reports a value of t from a set of candidate values for t.
In one example, supporting (UE-side) DL-UL reciprocity is conditioned on DL-UL impedance mismatch being IM≤u, where u is a certain impedance value or threshold. The value u can be fixed. The value u can be configured. The value u itself can be a part of the UE capability report, i.e. the UE reports a value of u from a set of candidate values for u.
In one example, supporting (UE-side) DL-UL reciprocity is conditioned on DL-UL impedance mismatch being IM<u, where u is a certain impedance value or threshold. The value u can be fixed. The value u can be configured. The value u itself can be a part of the UE capability report, i.e. the UE reports a value of u from a set of candidate values for u.
In one example, supporting (UE-side) DL-UL reciprocity is conditioned on DL-UL FD duplexing distance being Δf≤F, where F is a certain frequency value or threshold. The value F can be fixed. The value F can be configured. The value F itself can be a part of the UE capability report, i.e. the UE reports a value of F from a set of candidate values for F.
In one example, supporting (UE-side) DL-UL reciprocity is conditioned on DL-UL FD duplexing distance being Δf<F, where F is a certain frequency value or threshold. The value F can be fixed. The value F can be configured. The value F itself can be a part of the UE capability report, i.e. the UE reports a value of F from a set of candidate values for F.

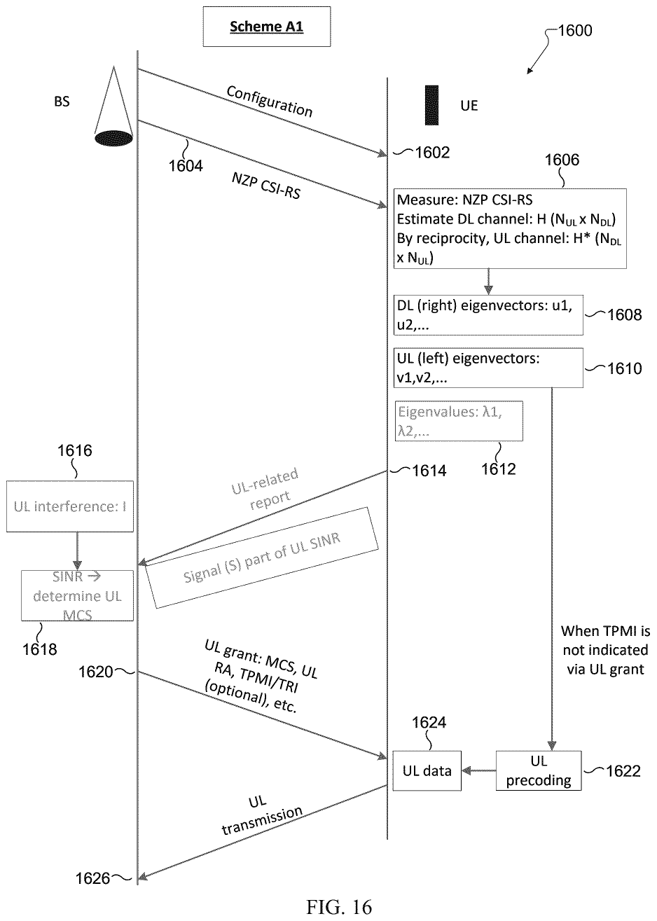

FIG. 16 illustrates a signal flow of an example procedure 1600 for UL-related reporting according to embodiments of the present disclosure. For example, procedure 1600 can be performed by the UE 112 and the gNB 102 and/or network 130 in the wireless network 100 of FIG. 1. This example is for illustration only and other embodiments can be used without departing from the scope of the present disclosure.

The procedure begins in 1602, a BS transmits a configuration to a UE. In 1604, the BS transmits a NZP CSI-RS to the UE. In 1606, the UE measures NZP CSI-RS, estimates the DL channel H (N_{UL}×N_{DL}), and by reciprocity estimates the UL channel H*(N_{UL}×N_{DL}). In 1608, the UE determines DL (right) eigenvectors u₁, u₂, . . . . In 1610, the UE determines UL (left) eigenvectors v₁, v₂, . . . . In 1612, the UE determines eigenvalues λ₁, λ₂, . . . . In 1614, the UE transmits an UL-related report and Signal (S) part of UL SINR to the BS. In 1616, the BS determines UL interference: I. In 1618, the BS determines SINR→determine UL MCS. In 1620, the BS transmits UL grant: MCS, UL RA, TPMI/TRI (optional), etc. to the UE. In 1622, when TPMI is not indicated via UL grant, the UE determines/performs UL precoding. In 1624, the UE determines UL data. In 1626, the UE transmits UL transmission to the BS.

In one embodiment, as shown in FIG. 16, a UE receives a configuration or/and indication (e.g. an RRC message, IE, or parameter, or/and a DCI trigger or codepoint) including information about at least one NZP CSI-RS and an UL-related report. The UE, in response, measures the at least one NZP CSI-RS and based on the measurement, determines the UL-related report assuming that UL and DL channels are reciprocal (e.g. for TDD scenarios). The report includes an indicator (or UCI parameter) indicating a signal (S) part/component for UL SINR calculation, where the signal S can be based on eigenvalue(s) λ₁, . . . associated with υ≥1 layers, or based on estimated UL channel. The eigenvalue(s) can be based in DL channel estimation (based on the measurement of NZP CSI-RS) as described herein.

The NW/gNB, upon reception of the UL-related report, can use the signal S to calculate UL SINR when the UL interference I is available at the NW/gNB. The calculated UL SINR can then be used for UL MCS selection in order to improve UL link adaptation for upcoming UL transmission(s) (e.g. via DCI with UL-grant for PUSCH transmission). The UL-grant includes UL resource allocation (UL RA), i.e., a set of PRBs for UL transmission and the determined UL MCS. The UL-grant may optionally include at least one of UL rank (TRI) and UL precoding (TPMI). When TPMI is not included in the UL-grant, the UE can use the determined UL (left) eigenvectors {vₗ} for UL precoding. When TRI is not included in the UL-grant, the UL rank can be fixed (e.g. 1), or configured via higher layer (e.g. via PUSCH-Config).

In one example, the signal S part can be calculated/determined according to at least one of the following examples.
In one example, S=∥H_{UL}∥² i.e., square of norm of H_{UL}. The norm of a vector y=[y₁ . . . , y_{Y}] can be defined as

$$‖ y ‖ = \sqrt{{\sum }_{i = 1}^{Y} abs {( {y}_{i} )}^{2}} .$$

In one example, S=∥H_{UL}P_{UL}∥² where P_{UL} is an UL precoding vector/matrix. In one example, when NW indicates TRI, the UE determines corresponding P_{UL}, but does not report it. In one example, when NW indicates TRI, the UE determines corresponding P_{UL} and reports it. In one example, the UE determines TRI and P_{UL}, and reports TRI only. In one example, the UE determines TRI and P_{UL}, reports both.
In one example, for layer l, the signal part is sₗ=λₗ (eigenvalue). The (per-layer) signal S then is [s₁ . . . s_{υ}] (υ=rank).
In one example,

$$S = {\sum }_{l = 1}^{υ} {λ}_{l} or \frac{1}{υ} {\sum }_{l = 1}^{υ} {λ}_{l} or {\sum }_{l = 1}^{υ} {λ}_{l}^{2} or \frac{1}{υ} {\sum }_{l = 1}^{υ} {λ}_{l}^{2} .$$

In one example, for a set of subcarriers X, the signal S can be summed (averaged) over X, i.e.,

$$S = {\sum }_{k ∈ X} S ( k ) or \frac{1}{{N}_{X}} {\sum }_{k ∈ X} S ( k )$$

where N_{X} is a number of subcarriers in X and S(k) is according to one of examples herein, calculated at subcarrier k in the set X.

In one example, the granularity of the reporting of S in frequency domain (FD) is according to at least one of the following examples.
In one example, the granularity in FD is WB, i.e., one value or multiple values are reported, as described herein, and the reported value(s) is for the entire reporting band configured for the reporting. The resolution (number of bits) for this WB reporting can be fixed (e.g. 4 or 5 or 6 or 7 bits), or configured from a candidate set of values, e.g. from {3, 4, . . . , 10}.
In one example, the granularity in FD is SB, i.e., one value or multiple values are reported, as described herein, for each SB in the reporting band configured for the reporting. That is, if number of SBs N_{SB}>1, then for each of N_{SB} SBs, one value or multiple values are reported, as described above. This SB reporting can be independent/separate for each SB. Or, it can be differential w.r.t. to a WB value. The number of bits for reporting WB and (differential) SB values can be N_{WB} and N_{SB} where N_{WB}>N_{SB}. In one example, N_{WB} and N_{SB} are fixed. In one example, N_{WB} is configured (e.g., according to one or more examples described herein), and N_{SB} is configured. In one example, N_{WB} is fixed (e.g., according to one or more examples described herein), and N_{SB} is fixed (e.g. 1 or 2 or 3 bits). In one example, N_{WB} and N_{SB} are configured (e.g., according to one or more examples described herein).
In one example, the granularity in FD is PRG-level, where a resource block group (RBG) is a set (number) of consecutive virtual resource blocks.
In one example, the granularity in FD depends on a target UL RA. For example, the number of FD units N_{FD} for reporting can be fixed (e.g. 2, 4, 8, or 16) or configured/indicated (via RRC or/and MAC CE or/and DCI). The size of each

$$FD unit = ⌈ \frac{{N}_{ULRA}}{{N}_{FG}} ⌉ or \frac{{N}_{ULRA}}{{N}_{FG}} or ⌊ \frac{{N}_{ULRA}}{{N}_{FG}} ⌋$$

where N_{ULRA} is the number of PRBs in the target UL RA. The target UL RA can be within or included in the measurement BW of NZP CSI-RS.

In one example, the granularity of the reporting of S in spatial domain (SD) is according to at least one of the following examples.
In one example, one value (common across layers) is reported regardless of number of layers (υ).
In one example, one value for each layer is reported, i.e., the indicator indicates υ≥1 values, one for each of u layers.
In one example, one value per up to a rank value (e.g. 4) in a CW (of the transport block, TB) is reported, i.e., the indicator indicates one value for each CW. When there are multiple layers associated with (mapped to) a CW, the corresponding value applies to the multiple layers. The mapping of layers to CWs can be fixed, or configured (e.g. via RRC or/and DCI) or reported by the UE (e.g. via CSI report over UCI or/and UE capability report). The number of value(s) included in the report can be fixed (e.g. 1 or u or number of CWs), or configured (e.g. via RRC or/and DCI), or reported by the UE (e.g. via CSI report over UCI or/and UE capability report). When reported by the UE, a CSI/UCI part 1 of a two-part CSI/UCI can be used/configured for reporting.
In one example, υ layers can be divided into G groups of layers, and the report corresponds to or associated with (or provides information about) one of or a subset of or all of the group of layers, i.e., the indicator indicates one value for a group of layers or one value for each of a subset of or all of the group of layers. When there are multiple layers associated with (mapped to) a group of layers, the corresponding value applies to the multiple layers within the group. The mapping of layers to groups of layers can be fixed, or configured (e.g. via RRC or/and DCI) or reported by the UE (e.g. via CSI report over UCI or/and UE capability report). The number of value(s) included in the report can be fixed (e.g. 1 or υ or number of CWs), or configured (e.g. via RRC or/and DCI), or reported by the UE (e.g. via CSI report over UCI or/and UE capability report). When reported by the UE, a CSI/UCI part 1 of a two-part CSI/UCI can be used/configured for reporting.

In one example, at least one of the following examples can be used for reporting the value(s).
In one example, the value(s) or square of value(s), i.e., their powers are reported in a linear scale.
In one example, the value(s) or square of value(s), i.e., their powers are reported in a logarithmic scale (e.g. dB). In one example, a value x in the logarithmic scale is given by 10 log₁₀ x or 10 log₁₀ x²=20 log₁₀ x.
In one example, the value(s) or square of value(s) (in linear or logarithmic scale) are reported in an absolute manner, i.e., independently/separately for each value.
In one example, the value(s) or square of value(s) (in linear or logarithmic scale) are reported in a differential manner.
   In one example, when the signal part S is based on eigenvalues, and since eigenvalues are monotonic, non-increasing, i.e., λ₁≥λ₂≥ . . . , S=[σ₁ σ₂ . . . ] where for i=1, σ₁=Q₁(λ₁), a quantized value based on λ₁ and for i>1, σᵢ=Q₂(f(λᵢ₋₁,λᵢ)), a quantized value based on f(λᵢ₋₁,λᵢ) denoting a relative value of λᵢ w.r.t. λᵢ₋₁. Here, Q₁ and Q₂ denote quantizers/codebooks.
      In one example, f(λᵢ₋₁,λᵢ)=λᵢ−λᵢ₋₁. At the receiver, based on received S, value(s) can be represented (reconstructed) as a summation

$${\sum }_{k = 1}^{i} {σ}_{k} .$$

Note that f(λᵢ₋₁,λᵢ)≤0. Hence, Q₂ quantizes zero or negative (i.e. non-positive) values.
In one example,

$$f ( {λ}_{i - 1} , {λ}_{i} ) = \frac{{λ}_{i}}{{λ}_{i - 1}} .$$

At the receiver, based on received S, value(s) can be represented (reconstructed) as a product

$${\prod }_{k = 1}^{i} {σ}_{k} .$$

Note that f(λᵢ₋₁,λᵢ)≤1.
In one example, when the signal part S is based on eigenvalues, and since eigenvalues are monotonic, non-increasing, i.e., λ₁≥λ₂≥ . . . , S=[σ₁ σ₂ . . . ] where for i=1, σ₁=Q₁(λ₁), a quantized value based on λ₁ and for i>1, σᵢ=−Q₂(f(λᵢ₋₁,λᵢ)), a quantized value based on f(λᵢ₋₁,λᵢ) denoting a relative value of λᵢ w.r.t. λᵢ₋₁. Here, Q₁ and Q₂ denote quantizers/codebooks.
   In one example, f(λᵢ₋₁,λᵢ)=λᵢ₋₁−λᵢ or abs(λᵢ−λᵢ₋₁) (absolute value). At the receiver, based on received S, value(s) can be represented (reconstructed) as a summation

$${\sum }_{k = 1}^{i} {σ}_{k} .$$

Note that f(λᵢ₋₁,λᵢ)≥0. Hence, Q₂ quantizes zero or positive (i.e. non-negative) values.

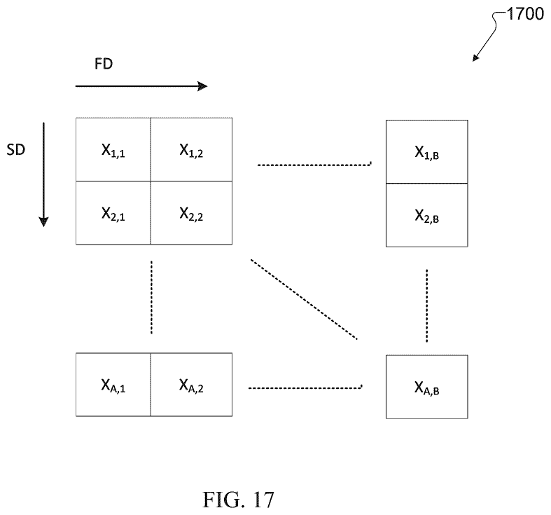

FIG. 17 illustrates an example matrix 1700 according to embodiments of the present disclosure. For example, matrix 1700 can be utilized by any of the UEs 111-116 of FIG. 1, such as the UE 113. This example is for illustration only and other embodiments can be used without departing from the scope of the present disclosure.

In one example, for a value range between 0 and 1, the quantizer/codebook in logarithmic scale include values in set

$$\{ \frac{1}{{2}^{\frac{N - q}{s}}} \} or \{ 1 - \frac{1}{{2}^{\frac{N - q}{s}}} \} .$$

In one example, q=0, 1, . . . , N−1. In one example,

$$s ∈ \{ \frac{1}{2} , \frac{1}{4} \}$$

In one example, N∈{2,3,4}.

In one example, for SB reporting, as shown in FIG. 17, S is a A×B matrix, where A and B are number of reported values in SD and FD, respectively. In one example, A=υ (number of layers). In one example, B=N_{SB} (number of SBs). In SD, values are monotonic non-increasing, i.e., i.e., X_{1,b}≥X_{2,b}≥ . . . ≥X_{A,b} for any (column) SB index b∈{1, 2, . . . , B}.
In one example, the index (b*) of the strongest/largest value X_{1,b*} (from first (SD) row, {X_{1,1}, X_{1,2}, . . . , X_{1,B}}) is reported, e.g. using ┌log₂ B┐ bits, and the rest of AB−1 values are normalized (divided by X_{1,b*}), before reporting. When B=1, the index (b*) is not reported. The value of X_{1,b*} can be fixed (e.g. 1), or reported.
In one example, AB values are reported independently.

In one example, the metric for reporting S can be according at least one of the following examples.
In one example, the metric corresponds to an RSRP value. In one example, the RSRP values or/and payload (number of bits) for reporting is the same as that for L1-RSRP reporting in [REF 9] and [REF 7].
In one example, the metric corresponds to power (or square of amplitude) or amplitude value. In one example, the power/amplitude values or/and payload (number of bits) for reporting is the same as that for amplitude reporting in Rel-15 or Rel-16 Type II or enhanced Type II codebook as described in [REF 9] and [REF 7].
In one example, the metric corresponds to eigenvalues associated with the υ “strongest” eigenvectors (with maximum values of eigenvalues) of the measured channel (e.g. DL channel measurement based on NZP CSI-RS). In one example, the eigenvalues or/and payload (number of bits) is the same as that for amplitude reporting in Rel-15 or Rel-16 Type II or enhanced Type II codebook as described in [REF 9] and [REF 7].

In one example, the at least one NZP CSI-RS or/and the report can be according at least one or a combination of multiple of the following examples.
In one example, the at least one NZP CSI-RS is aperiodic (AP), and the report is also AP. For example, a field (CSI request field) in a DCI (e.g. UL-DCI) can be used to trigger an AP CSI trigger state for the measurement and reporting. The measurement can be in a slot after the slot with the DCI, the slot can be determined based on a slot offset (which can be included in the trigger state definition).
In one example, the at least one NZP CSI-RS is a semi-persistent (SP) and the report is AP. In one example, a SP CSI-RS can be treated as a special case of AP, i.e. AP with K>1 measurement instances or K AP CSI-RSs, with a fixed separation (d) between two measurement instances or measurement RSs. For example, a field (CSI request field) in a DCI (e.g. UL-DCI) can be used to trigger a CSI trigger state with a SP CSI-RS (as described herein) for the measurement and reporting. The measurement can be in K slots after the slot with the DCI, the slots can be determined based on a slot offset (which can be included in the trigger state definition). The separation between two consecutive slots d can be fixed (e.g. 1 or 2) or configured (via RRC) or indicates (via DCI, e.g. as part of the CSI trigger state).
In one example, the at least one NZP CSI-RS is periodic (P)/SP NZP CSI-RS and the report is SP. In one example, the SP report is a special case of AP report, i.e. AP with L>1 reporting instances or L AP CSI reports, with a fixed separation (e) between two reporting instances or AP reports. A CSI trigger state can be triggered via a DCI or activated via a MAC CE for the measurement and reporting.
In one example, the at least one NZP CSI-RS is a P-NZP CSI-RS and the report is P-report. This configuration can be RRC-based.
In one example, the at least one NZP CSI-RS can be a CSI-RS for (DL) CSI, without any restriction.
In one example, the at least one NZP CSI-RS can be a CSI-RS for (DL) CSI, but with at least one restriction.
   In one example, the restriction can be based on a number of CSI-RS ports (P) such as P≤t, where t is a threshold. In one example, t can be fixed, e.g. t=number of antenna ports at UE, or t=8 or 16. In one example, t is configured subject to UE capability reporting on the max value P that the UE (e.g., the UE 116) can support.

In one example, the reporting of the report can be a standalone report (i.e. not multiplexed with any other report or UCI parameter). In one example, the report can be a non-standalone report, hence can be multiplexed together with another report or UCI parameter. When multiplexed with another report or UCI parameter, another report can be a (DL) CSI report and the UCI parameter can be at least one of RI, PMI, CQI, layer index (LI), CQI report interval (CRI), synchronization signal block (SSB) resource indicator (SSBRI), L1-RSRP, L1-SINR, and time-domain channel property (TDCP). In one example, the report can be standalone or non-standalone based on configuration (from the NW, e.g. RRC or/and MAC CE or/and DCI) or UE capability. In one example, the report can be a non-standalone report, and is a part of (included in) a (DL) CSI report, where the CSI report can include at least one of RI, PMI, CQI, LI, CRI.

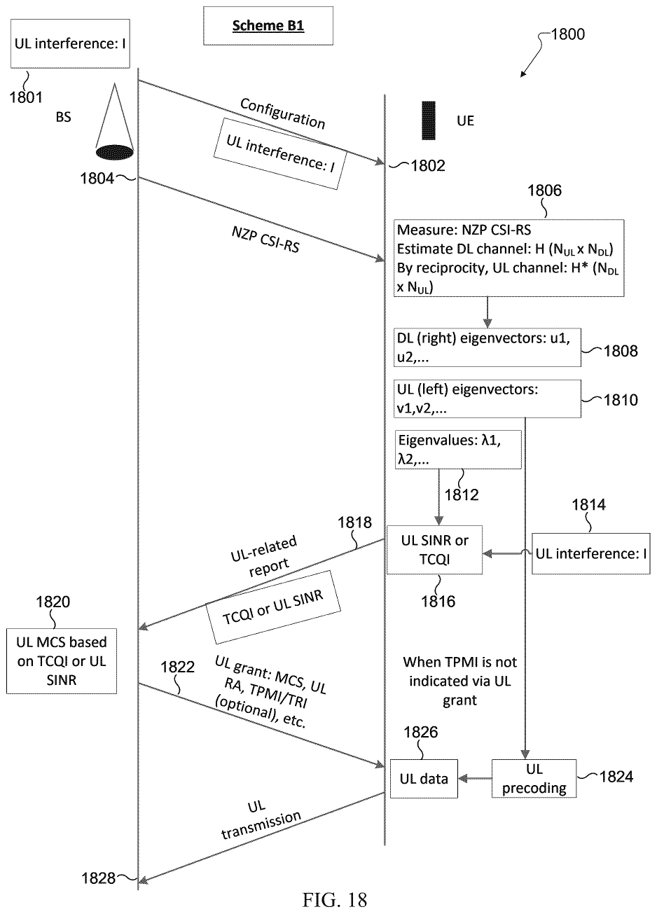

FIG. 18 illustrates a signal flow of an example procedure 1800 for UL-related reporting according to embodiments of the present disclosure. For example, procedure 1800 can be performed by the UE 114 and the gNB 102 and/or network 130 in the wireless network 100 of FIG. 1. This example is for illustration only and other embodiments can be used without departing from the scope of the present disclosure.

The procedure begin in 1801, a BS determines UL interference: I. In 1802, the BS transmits a configuration and UL interference: I to a UE. In 1804, the BS transmits a NZP CSI-RS to the UE. In 1806, the UE measures NZP CSI-RS, estimates the DL channel H (N_{UL}×N_{DL}), and by reciprocity estimates the UL channel H*(N_{DL}×N_{UL}). In 1808, the UE determines DL (right) eigenvectors u₁, u₂, . . . . In 1810, the UE determines UL (left) eigenvectors v₁, v₂, . . . . In 1812, the UE determines eigenvalues λ₁, λ₂, . . . . In 1814, the UE determines UL interference: I. In 1816, the UE determines UL SINR or transmit CQI (TCQI). In 1818, the UE transmits an UL-related report and TCQI or UL SINR. In 1820, the BS determines UL MCS based on TCQI or UL SINR. In 1822, the BS transmits UL grant: MCS, UL RA, TPMI/TRI (optional), etc. to the UE. In 1824, the UE determines/performs UL precoding. In 1826, when TPMI is not indicated via UL grant, the UE determines UL data. In 1828, the UE transmits UL transmission to the BS.

In one embodiment, as shown in FIG. 18, a UE receives a configuration or/and indication (e.g. an RRC message, IE, or parameter, or/and a DCI trigger or codepoint) including information about (i) UL interference I, (ii) at least one NZP CSI-RS, and (iii) an UL-related report. The UE, in response, measures the at least one NZP CSI-RS and based on the measurement and the UL interference I, determines the UL-related report assuming that UL and DL channels are reciprocal (e.g. for TDD scenarios). The report includes an indicator indicating a quality of UL channel. In one example, the quality of UL channel is quantified as UL SINR. In one example, the quality of UL channel is quantified as transmit CQI (TCQI). In one example, the quality of UL channel is quantified as UL MCS (TMCS). The UL SINR or TCQI or UL MCS is based on a signal (S) part/component and an interference part. The signal S can be based on eigenvalue(s) λ₁, . . . associated with υ≥1 layers, or based on estimated UL channel. The interference part is based on the UL interference I. The eigenvalue(s) can be based in DL channel estimation (based on the measurement of NZP CSI-RS) as described herein.

In one example, when the UL-related report includes UL SINR or TCQI, the NW/gNB, upon reception of the UL-related report, can use UL SINR or TCQI for UL MCS selection in order to improve UL link adaptation for upcoming UL transmission(s) (e.g. via DCI with UL-grant for PUSCH transmission). The UL-grant includes UL resource allocation (UL RA), i.e., a set of PRBs for UL transmission and the determined UL MCS. The UL-grant may optionally include at least one of UL rank (TRI) and UL precoding (TPMI). When TPMI is not included in the UL-grant, the UE can use the determined UL (left) eigenvectors {vₗ} for UL precoding. When TRI is not included in the UL-grant, the UL rank can be fixed (e.g. 1), or configured via higher layer (e.g. via PUSCH-Config).

In one example, when the UL-related report includes UL MCS, the NW/gNB, upon reception of the UL-related report, can accept the reported UL MCS for upcoming UL transmission(s) (e.g. via DCI with UL-grant for PUSCH transmission). The UL-grant includes UL resource allocation (UL RA), i.e., a set of PRBs for UL transmission and an acknowledgement (ACK) for the received UL MCS.
In one example, the ACK can be via a 1-bit field in the DCI carrying the UL-grant. This 1-bit field can replace the MCS field in DCI, or can be in addition to the MCS field. When only one of the 1-bit field and the MCS field can be present in the DCI, then a higher layer (e.g. RRC) or MAC CE indication can be used to indicate the presence of one of the two. When both the 1-bit field and the MCS field can be present in the DCI, then when the 1-bit field indicates ACK, the MCS field can be ignored by the UE or reserved (not used), otherwise (when the 1-bit field indicates NACK), the MCS field overrides the reported UL MCS value and indicates the UL MCS for the UL transmission(s).
In one example, the ACK can be via a codepoint of the MCS field in the DCI carrying the UL-grant. For example, when the codepoint=0, it corresponds to ACK, otherwise it corresponds to an UL MCS value.
In one example, the ACK can be implicit (without any field in DCI). For instance, UL MCS field can be absent from the UL-DCI. When absent, it acts an implicit ACK. When present, the UL MCS is provided via the UL-DCI. The information whether UL MCS field is absent or present can be higher layer configured (via a separate RRC parameter or a part of the CSI trigger state definition) or indicated via MAC CE or DCI. When DCI is used, a two-stage DCI can be used, where the stage 1 of the DCI indicates the information about present/absence of UL MCS, and when present, UL MCS is indicated via the stage 2 of the DCI.

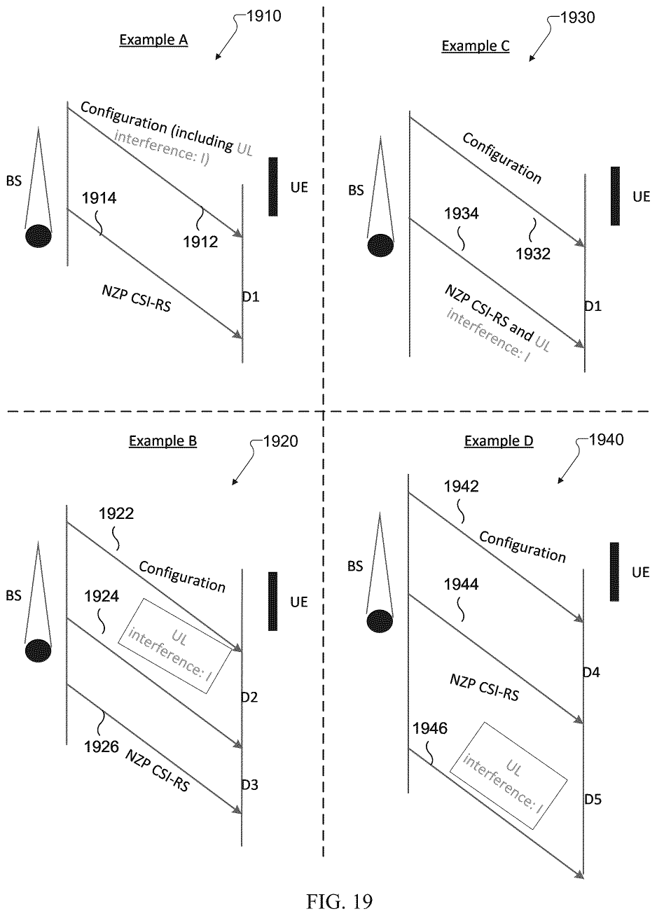

FIG. 19 illustrates signal flows of example procedures 1910, 1920, 1930, and 1940 for transmitting UL interference I according to embodiments of the present disclosure. For example, procedures 1910, 1920, 1930, and 1940 can be performed by the UE 114 and the gNB 102 and/or network 130 in the wireless network 100 of FIG. 1. This example is for illustration only and other embodiments can be used without departing from the scope of the present disclosure.

The procedure 1910 begins in 1912, a BS transmits a configuration (including UL interference: I) to a UE. In 1914, the BS transmits a NZP-CSI-RS to the UE.

The procedure 1920 begins in 1922, a BS transmits a configuration to a UE. In 1924, the BS transmits UL interference: I to the UE. In 1926, the BS transmits a NZP CSI-RS to the UE.

The procedure 1930 begins in 1932, a BS transmits a configuration to a UE. In 1934, the BS transmits a NZP CSI-RS and UL interference: I to the UE.

The procedure 1940 begins in 1942, a BS transmits a configuration to a UE. In 1944, a BS transmits a NZP CSI-RS to the UE. In 1946, the BS transmits UL interference: I to the UE.

As shown in FIG. 19, the timeline for receiving the UL interference I can be according to at least one of the following examples.
In example A, the UL interference I is provided together with the configuration. The NZP CSI-RS is received D₁ slots after receiving the configuration. The value of D₁ can be fixed, configured, or indicated via DCI.
   In one example, when the configuration is via RRC, the UL interference I can also be via RRC either as part of the configuration or a separate IE or RRC parameter.
   In one example, when the configuration is via RRC (e.g. CSI trigger state) which is triggered via a DCI, the UL interference can be via RRC either as part of the CSI trigger state or a separate IE or RRC parameter, or via the DCI (e.g. a codepoint of a DCI field).
In example B, the UL interference I is provided after the configuration but before CSI-RS. The UL interference I is received D₂ slots after receiving the configuration, and the NZP CSI-RS is received D₃ slots after receiving the UL interference I. The value of D₂ can be fixed, configured, or indicated via DCI. The value of D₃ can be fixed, configured, or indicated via DCI or determined based on the value of D₂.
In example C, the UL interference I is provided together with the NZP CSI-RS. The NZP CSI-RS and UL interference I are received D₁ slots after receiving the configuration. The value of D₁ can be fixed, configured, or indicated via DCI.
   In one example, when the configuration is via RRC, the UL interference I can also be via RRC either as part of the configuration for NZP CSI-RS or a separate IE or RRC parameter.
   In one example, when the configuration is via RRC (e.g. CSI trigger state) which is triggered via a DCI, the UL interference can be via RRC either as part of the CSI trigger state or as part of the configuration for NZP CSI-RS or a separate IE or RRC parameter, or via the DCI (e.g. a codepoint of a DCI field).
In example D, the UL interference I is provided after NZP CSI-RS. The NZP CSI-RS is received D₄ slots after receiving the configuration, and the UL interference I is received D₅ slots after receiving the NZP CSI-RS. The value of D₄ can be fixed, configured, or indicated via DCI. The value of D₅ can be fixed, configured, or indicated via DCI or determined based on the value of D₄. In one example, the value of D₅ is such that the UL interference is received in a slot either before or no later than the slot of the CSI reference resource.

The signal S part of the UL SINR can be calculated/determined at the UE according to at least one of the examples described herein.

The granularity of the reporting of the UL-related report (e.g. UL SINR, TCQI, or UL MCS) in frequency domain (FD) can be according to at least one of the examples described herein.

The granularity of the reporting of the UL-related report (e.g. UL SINR, TCQI, or UL MCS) in spatial domain (SD) can be according to at least one of the examples described herein.

The reporting of the value(s) in the UL-related report (e.g. UL SINR, TCQI, or UL MCS) can be according to at least one of the examples described herein.

For SB reporting, the UL-related report (e.g. UL SINR, TCQI, or UL MCS) can be according to at least one of the examples described herein.

The at least one NZP CSI-RS or/and the report can be according at least one or a combination of multiple of the examples described herein.

The reporting of the report can be a standalone report (i.e. not multiplexed with any other report or UCI parameter). In one example, the report can be a non-standalone report, hence can be multiplexed together with another report or UCI parameter. When multiplexed with another report or UCI parameter, another report can be a (DL) CSI report and the UCI parameter can be at least one of RI, PMI, CQI, LI, CRI, SSBRI, L1-RSRP, L1-SINR, and TDCP. In one example, the report can be standalone or non-standalone based on configuration (from the NW, e.g. RRC or/and MAC CE or/and DCI) or UE capability. In one example, the report can be a non-standalone report, and is a part of (included in) a (DL) CSI report, where the CSI report can include at least one of RI, PMI, CQI, LI, CRI.

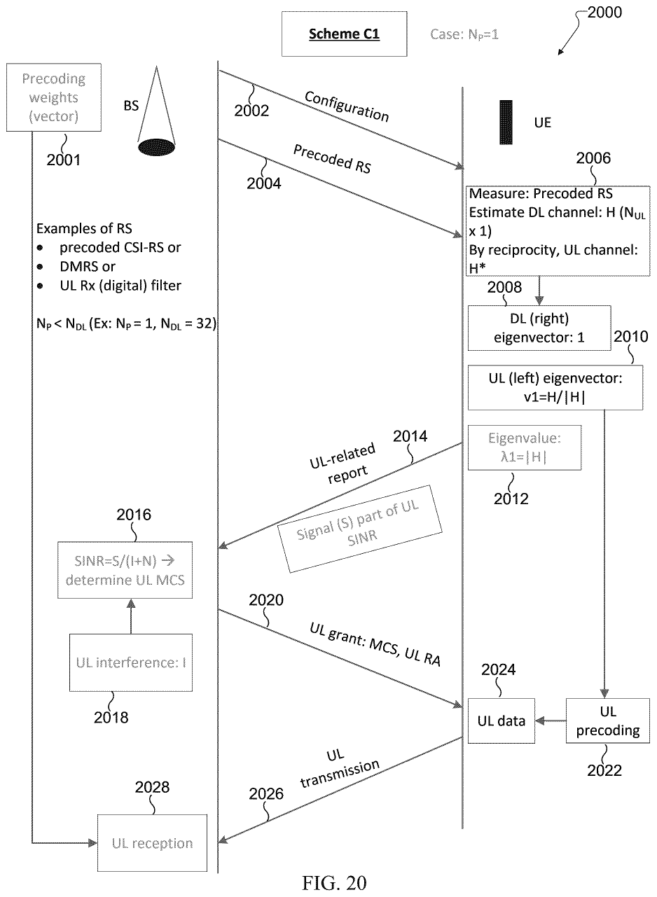

FIG. 20 illustrates a signal flow of an example procedure 2000 for UL-related reporting according to embodiments of the present disclosure. For example, procedure 2000 can be performed by the UE 115 and the gNB 102 and/or network 130 in the wireless network 100 of FIG. 1. This example is for illustration only and other embodiments can be used without departing from the scope of the present disclosure.

The procedure begins in 2001, a BS determines precoding weights (vector). In 2002, the BS transmit a configuration to a UE. In 2004, the BS transmits a precoded RS to the UE. In 2006, the UE measures precoded RS, estimates the DL channel H (N_{UL}×1), and by reciprocity estimates the UL channel H*. IN 2008, the UE determines DL (right) eigenvector: 1. In 2010, the UE determines UL (left) eigenvector: v1=H/|H|. In 2012, the UE determines eigenvalue λ₁=|H|. In 2014, the UE transmits an UL related report and Signal (S) part of UL SIRNR to the BS. In 2016, the BS determines SINR=S/(1+N)→determine UL MCS. In 2018, the BS determines UL interference: I. In 2020, the BS transmits UL grant: MCS, UL RA. In 2022, the UE determines/performs UL precoding. In 2024, the UE determines UL data. In 2026, the UE transmits UL transmission to the BS. In 2028, the BS receives the UL reception.

In one embodiment, as shown in FIG. 20, a UE receives a configuration or/and indication (e.g. an RRC message, IE, or parameter, or/and a DCI trigger or codepoint) including information about at least one DL RS and an UL-related report where the DL RS is pre-coded, hence referred to as pre-coded RS in this disclosure. The UE, in response, measures the at least one pre-coded RS and based on the measurement, determines the UL-related report assuming that UL and DL channels are reciprocal (e.g. for TDD scenarios). The report includes an indicator indicating a signal (S) part/component for UL SINR calculation, where the signal S can be based on eigenvalue(s) λ₁, . . . associated with υ≥1 layers, or based on estimated UL channel. The eigenvalue(s) can be based in DL channel estimation (based on the measurement of NZP CSI-RS) as described herein.

In one example, the pre-coded RS is an NZP CSI-RS. In one example, the pre-coded RS is a demodulation reference signal (DMRS). In one example, the pre-coded RS is based on an UL Rx (digital/baseband) filter that NW/gNB (e.g., the network 130/the BS 102) can use to receive UL transmission from the UE.

The pre-coding on the RS can be UE-specific (i.e. separate for each UE connected to the NW/gNB). Since N_{DL}>N_{P} (the number ports in the pre-coded RS), gNB/NW can assign DL ports across UEs in UE-specific manner for pre-coded RS.

When N_{P}=1, as shown in the figure, the channel H=h (a column vector) essentially is SIMO (single-input multiple-output), hence the DL (right) eigenvector is 1, the UL (left) eigenvector is

$${ν}_{1} = \frac{h}{\vert h \vert} ,$$

and the eigenvalue λ₁=|h|. Note that in this case, the UE may not need to perform EVD.

The NW/gNB, upon reception of the UL-related report, can use the signal S to calculate UL SINR when the UL interference I is available at the NW/gNB. The calculated UL SINR can then be used for UL MCS selection in order to improve UL link adaptation for upcoming UL transmission(s) (e.g. via DCI with UL-grant for PUSCH transmission). The UL-grant includes UL resource allocation (UL RA), i.e., a set of PRBs for UL transmission and the determined UL MCS. The UE uses the determined UL (left) eigenvectors 11 for UL precoding. Note that the UL rank is either fixed to 1 or configured via higher layer (e.g. via PUSCH-Config) to a value 1.

The signal S part of the UL SINR can be calculated/determined at the UE according to at least one of the examples described herein.

The granularity of the reporting of S in frequency domain (FD) can be according to at least one of the examples described herein.

The granularity of the reporting of S in spatial domain (SD) can be according to at least one of the examples described herein.

The reporting of the value(s) for S can be according to at least one of the examples described herein.

For SB reporting, S can be reported according to at least one of the examples described herein.

The metric for reporting S can be according to at least one of the examples described herein.

The at least one NZP CSI-RS or/and the report can be according at least one or a combination of multiple of the examples described herein.

The reporting of the report can be a standalone report (i.e. not multiplexed with any other report or UCI parameter). In one example, the report can be a non-standalone report, hence can be multiplexed together with another report or UCI parameter. When multiplexed with another report or UCI parameter, another report can be a (DL) CSI report and the UCI parameter can be at least one of RI, PMI, CQI, LI, CRI, SSBRI, L1-RSRP, L1-SINR, and TDCP. In one example, the report can be standalone or non-standalone based on configuration (from the NW, e.g. RRC or/and MAC CE or/and DCI) or UE capability. In one example, the report can be a non-standalone report, and is a part of (included in) a (DL) CSI report, where the CSI report can include at least one of RI, PMI, CQI, LI, CRI.

When N_{P}>1, the measurement and reporting are the same as in one or more embodiments described herein (by replacing NZP CSI-RS with the pre-coded NZP CSI-RS).

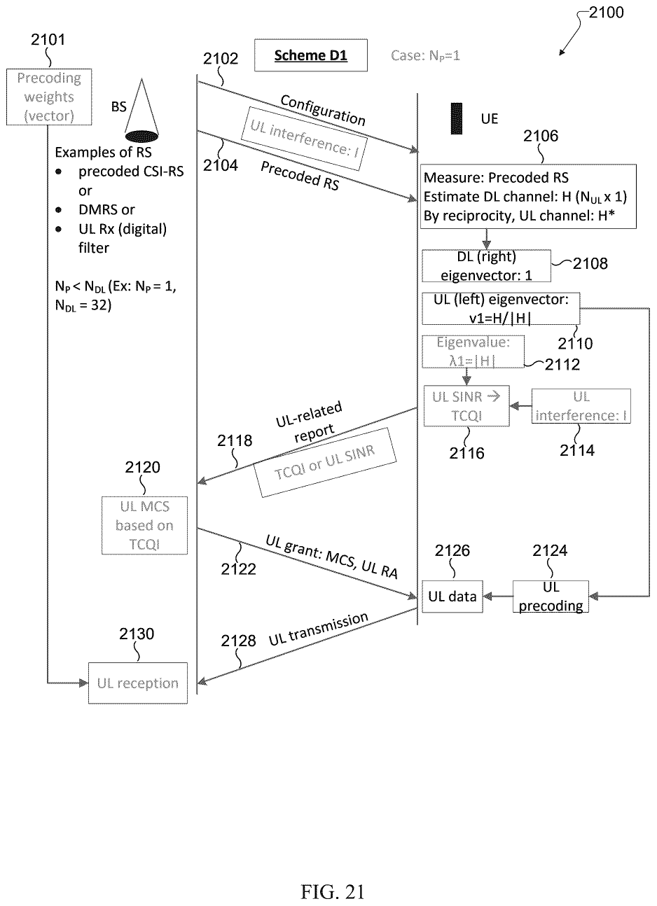

FIG. 21 illustrates a signal flow of an example procedure 2100 for UL-related reporting according to embodiments of the present disclosure. For example, procedure 2100 can be performed by the UE 116 and the gNB 102 and/or network 130 in the wireless network 100 of FIG. 1. This example is for illustration only and other embodiments can be used without departing from the scope of the present disclosure.

The procedure begins in 2101, a BS determines precoding weights (vectors). In 2102, the BS transmits a configuration to a UE. In 2104, the BS transmits the precoded RS to the UE. In 2106, the UE measures precoded RS, estimates the DL channel H (N_{UL}×1), and by reciprocity estimates the UL channel H*. In 2108, the UE determines DL (right) eigenvector: 1. In 2110, the UE determines UL (left) eigenvector: v1=H/|H|. In 2112, the UE determines eigenvalue λ₁=|H|. In 2114, the UE determines UL interference: I. In 2116, the UE determines UL SINR→TCQI. In 2118, the UE transmits UL-related report and TCQI or UL SINR to the BS. In 2120, the BS determines UL MCS based on TCQI. In 2122, the BS transmits UL grant: MCS, UL RA to the UE. In 2124, the UE determines/performs UL precoding. In 2126, the UE determines UL data. In 2128, the UE transmits UL transmission to the BS. In 2130, the BS receives the UL reception.

In one embodiment, as shown in FIG. 21, a UE receives a configuration or/and indication (e.g. an RRC message, IE, or parameter, or/and a DCI trigger or codepoint) including information about (i) UL interference I, (ii) at least one DL RS, and (iii) an UL-related report where the DL RS is pre-coded, hence referred to as pre-coded RS in this disclosure. The UE, in response, measures the at least one pre-coded RS and based on the measurement and the UL interference I, determines the UL-related report assuming that UL and DL channels are reciprocal (e.g. for TDD scenarios). The report includes an indicator indicating a quality of UL channel. In one example, the quality of UL channel is quantified as UL SINR. In one example, the quality of UL channel is quantified as transmit CQI (TCQI). The UL SINR or TCQI is based on a signal (S) part/component and an interference part. The signal S can be based on eigenvalue(s) λ₁, . . . associated with υ≥1 layers, or based on estimated UL channel. The interference part is based on the UL interference I.

In one example, the pre-coded RS is an NZP CSI-RS. In one example, the pre-coded RS is a DMRS. In one example, the pre-coded RS is based on an UL Rx (digital/baseband) filter that NW/gNB can use to receive UL transmission from the UE.

The pre-coding on the RS can be UE-specific (i.e. separate for each UE connected to the NW/gNB). Since N_{DL}>N_{P} (the number ports in the pre-coded RS), gNB/NW can assign DL ports across UEs in UE-specific manner for pre-coded RS.

When N_{P}=1, as shown in the figure, the channel H=h (a column vector) essentially is SIMO (single-input multiple-output), hence the DL (right) eigenvector is 1, the UL (left) eigenvector is

$${ν}_{1} = \frac{h}{\vert h \vert} ,$$

and the eigenvalue λ₁=|h|. Note that in this case, the UE (e.g., the UE 116) may not need to perform EVD.

The NW/gNB, upon reception of the UL-related report, can use UL SINR or TCQI for UL MCS selection in order to improve UL link adaptation for upcoming UL transmission(s) (e.g. via DCI with UL-grant for PUSCH transmission). The UL-grant includes UL resource allocation (UL RA), i.e., a set of PRBs for UL transmission and the determined UL MCS. The UE uses the determined UL (left) eigenvectors v₁ for UL precoding. Note that the UL rank is either fixed to 1 or configured via higher layer (e.g. via PUSCH-Config) to a value 1.

The timeline for receiving the UL interference I can be according to at least one of the examples (A/B/C/D), illustrated in FIG. 19 and described in one or more embodiments herein.

The signal S part of the UL SINR can be calculated/determined at the UE according to at least one of the examples described herein.

The granularity of the reporting of the UL-related report (e.g. UL SINR, TCQI, or UL MCS) in frequency domain (FD) can be according to at least one of the examples described herein.

The granularity of the reporting of the UL-related report (e.g. UL SINR, TCQI, or UL MCS) in spatial domain (SD) can be according to at least one of the examples described herein.

The reporting of the value(s) in the UL-related report (e.g. UL SINR, TCQI, or UL MCS) can be according to at least one of the examples described herein.

For SB reporting, the UL-related report (e.g. UL SINR, TCQI, or UL MCS) can be according to at least one of the examples described herein.

The at least one NZP CSI-RS or/and the report can be according at least one or a combination of multiple of the examples described herein.

The reporting of the report can be a standalone report (i.e. not multiplexed with any other report or UCI parameter). In one example, the report can be a non-standalone report, hence can be multiplexed together with another report or UCI parameter. When multiplexed with another report or UCI parameter, another report can be a (DL) CSI report and the UCI parameter can be at least one of RI, PMI, CQI, LI, CRI, SSBRI, L1-RSRP, L1-SINR, and TDCP. In one example, the report can be standalone or non-standalone based on configuration (from the NW, e.g. RRC or/and MAC CE or/and DCI) or UE capability. In one example, the report can be a non-standalone report, and is a part of (included in) a (DL) CSI report, where the CSI report can include at least one of RI, PMI, CQI, LI, CRI.

When N_{P}>1, the measurement and reporting are the same as in one or more embodiments described herein (by replacing NZP CSI-RS with the pre-coded NZP CSI-RS).

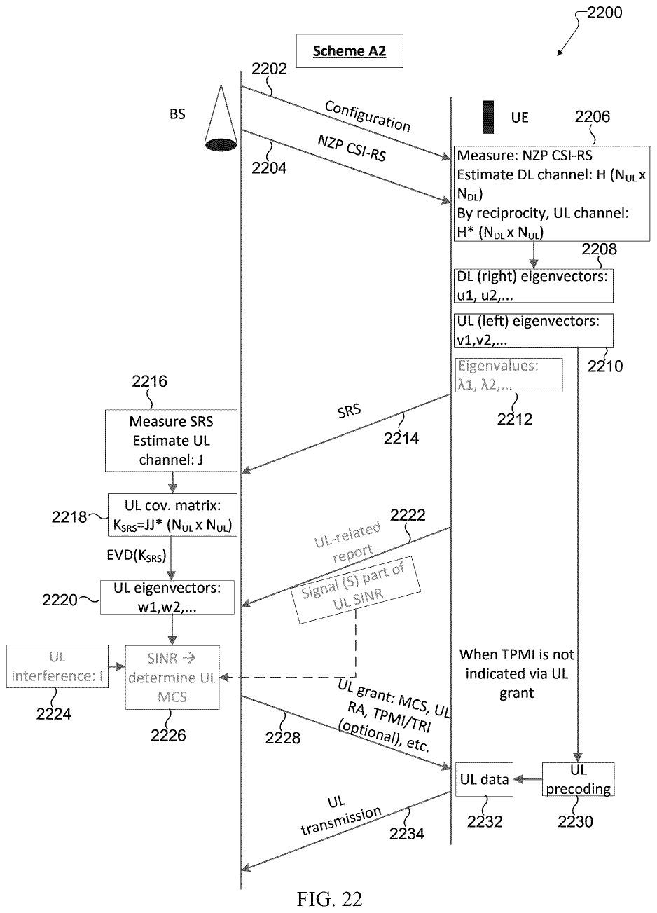

FIG. 22 illustrates a signal flow of an example procedure 2200 for UL-related reporting according to embodiments of the present disclosure. For example, procedure 2200 can be performed by the UE 116 and the gNB 102 and/or network 130 in the wireless network 100 of FIG. 1. This example is for illustration only and other embodiments can be used without departing from the scope of the present disclosure.

The procedure begins in 2202, a BS transmits a configuration to a UE. In 2204, the BS transmits a NZP CSI-RS to the UE. In 2206, the UE measures the NZP CSI-RS, estimates the DL channel H (N_{DL}×N_{UL}), and by reciprocity estimates the UL channel H*(N_{DL}×N_{UL}). In 2208, the UE determines DL (right) eigenvectors: u₁, u₂, . . . . In 2210, the UE determines UL (left) eigenvectors: v₁, v₂, . . . . In 2212, the UE determines eigenvalues: λ₁, λ₂, . . . . In 2214, the UE transmits SRS to the BS. In 2216, the BS measures SRS and estimates the UL channel: J. In 2218, the BS determines UL cov. Matrix: K_{SRS}=JJ*(N_{UL}×N_{UL}). In 2220, the BS determines UL eigenvectors w₁, w₂, . . . . In 2222, the UE transmits an UL-related report and Signal (S) part of UL SINR. In 2224, the BS determines UL interference: I. In 2226, the BS determines SINR→determine UL MCS. In 2228, the BS transmits UL grant: MCS, UL RA to the UE. In 2230, when TPMI is not indicated via UL grant, the UE determines/performs UL precoding. In 2232, the UE determines UL data. In 2234, the UE transmits UL transmission to the BS.

In one embodiment, as a variation of scheme A1 (described one or more embodiments herein), shown in FIG. 22, the procedure includes an additional step on SRS transmission from the UE. The UE can estimate UL channel (denoted as J) based on SRS measurement. The eigenvectors {wₗ} of the UL channel J can approximate (left) UL eigenvectors vₗ determined at the UE based on CSI-RS measurement, as described herein. The estimated UL channel J or/and eigenvectors {wₗ} can be used for any one of the following purposes:
In one example, UL SINR can be calculated by the NW/gNB (e.g., the network 130/the BS 102) based on the received S, UL interference I, and UL channel J (may also be based on eigenvectors wₗ determined based on J). The UL MCS can then be selected based on the calculated UL SINR. In one example,

$$SINR = \frac{ζ}{I + N}$$

where ζ is a function of S, J, wₗ or S, J. For example, for rank 1, ζ=SƒJw₁∥² or S∥J∥². Or, for rank 1, ζ=x₁S+x₂∥Jw₁∥² or x₁S+x₂∥J∥² where x₁ and x₂ are two weights such that X₁+x₂=1 and 0≤xᵢ≤1.
In one example, the UL channel J can be used to determine eigenvectors {wₗ} or UL precoder(s), and corresponding TPMI(s) indicating the UL precoder(s). The TPMI(s) can be indicated via the UL-grant.
In one example, the UL channel J can be used to determine UL rank, and corresponding TRI indicating the UL rank. The TRI can be indicated via the UL-grant.

The rest of the details in one or more embodiments described herein apply to this embodiment as well, hence omitted for brevity.

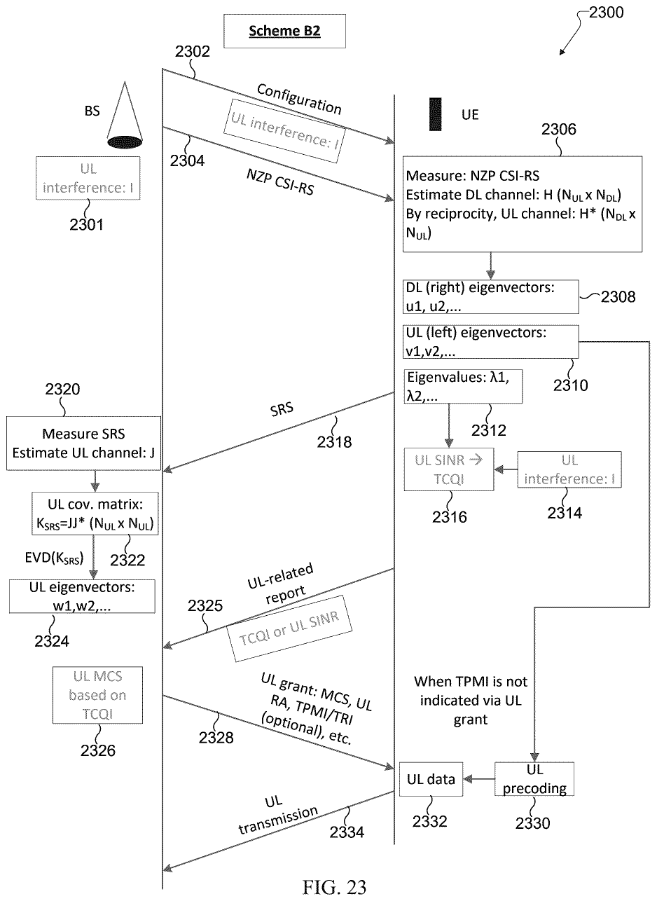

FIG. 23 illustrates a signal flow of an example procedure 2300 for UL-related reporting according to embodiments of the present disclosure. For example, procedure 2300 can be performed by the UE 116 and the gNB 102 and/or network 130 in the wireless network 100 of FIG. 1. This example is for illustration only and other embodiments can be used without departing from the scope of the present disclosure.

The procedure begins in 2301, a BS determines UL interference: I. In 2302, a BS transmits a configuration and UL interference: I to a UE. In 2304, the BS transmits a NZP CSI-RS to the UE. In 2306, the UE measures the NZP CSI-RS, estimates the DL channel H (N_{UL}×N_{DL}), and by reciprocity estimates the UL channel H*(N_{DL}×N_{UL}). In 2308, the UE determines DL (right) eigenvectors u₁, u₂, . . . . In 2310, the UE determines UL (left) eigenvectors v₁, v₂, . . . . In 2312, the UE determines eigenvalues λ₁, λ₂, . . . . In 2314, the UE determines UL interference: I. In 2316, the UE determines UL SINR→TCQI. IN 2318, the UE transmits SRS to the BS. In 2320, the BS measures SRS and estimates UL channel: J. In 2322, the BS determines UL cov. Matrix: K_{SRS}=JJ*(N_{UL}×N_{UL}). In 2324, the BS determines UL eigenvectors w₁, w₂, . . . . In 2325, the UE transmits UL-related report and TCQI or UL SINR to the BS. In 2326, the BS determines UL MCS based on TCQI. In 2328, the BS transmits UL grant: MCS, UL RA, TPMI/TRI (optional), etc. to the UE. In 2330, when the TPMI is not indicated via UL grant, the UE determines/performs UL precoding. In 2332, the UE determines UL data. In 2334, the UE transmits UL transmission to the BS.

In one embodiment, as a variation of scheme B1 (described in one or more embodiments herein), shown in FIG. 23, the procedure includes an additional step on SRS transmission from the UE. The UE can estimate UL channel (denoted as J) based on SRS measurement. The eigenvectors {wₗ} of the UL channel J can approximate (left) UL eigenvectors vₗ determined at the UE based on CSI-RS measurement, as described herein. The estimated UL channel J or/and eigenvectors {wₗ} can be used for any one of the following purposes:
In one example, UL SINR can be calculated by the NW/gNB based on the received TCQI (received UL SINR, denoted as SINRᵣₓ), and UL channel J (may also be based on eigenvectors wₗ determined based on J). The UL MCS can then be selected based on the calculated UL SINR. In one example, the calculated SINR=γ where γ is a function of SINRᵣₓ, J, wₗ or SINRᵣₓ, J. For example, for rank 1, γ=SINRᵣₓ∥Jw₁∥² or SINRᵣₓ∥J∥². Or, for rank 1, γ=x₁SINRᵣₓ+x₂∥Jw₁∥² or x₁SINRᵣₓ+x₂∥J∥² where x₁ and x₂ are two weights such that x₁+x₂=1 and 0≤xᵢ≤1.
In one example, the UL channel J can be used to determine eigenvectors {wₗ} or UL precoder(s), and corresponding TPMI(s) indicating the UL precoder(s). The TPMI(s) can be indicated via the UL-grant.
In one example, the UL channel J can be used to determine UL rank, and corresponding TRI indicating the UL rank. The TRI can be indicated via the UL-grant.

The rest of the details in one or more embodiments described herein apply to this embodiment as well, hence omitted for brevity.

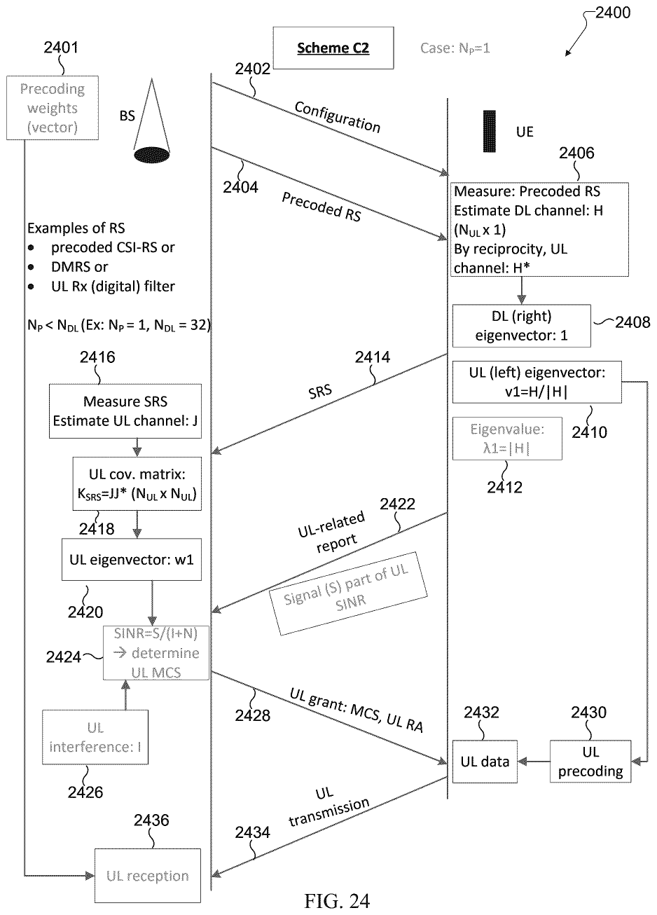

FIG. 24 illustrates a signal flow of an example procedure 2400 for UL-related reporting according to embodiments of the present disclosure. For example, procedure 2400 can be performed by the UE 111 and the gNB 102 and/or network 130 in the wireless network 100 of FIG. 1. This example is for illustration only and other embodiments can be used without departing from the scope of the present disclosure.

The procedure begins in 2401, a BS determines precoding weights (vectors). In 2402, the BS transmits a configuration to a UE. In 2404, the BS transmits the precoding RS to the UE. In 2406, the UE measures precoded RS, estimates the DL channel H (N_{UL}×1), and by reciprocity estimates the UL channel H*. In 2408, the UE determines DL (right) eigenvector: 1. In 2410, the UE determines UL (left) eigenvector: v1=H/|H|. In 2412, the UE determines eigenvalue λ₁=|H|. In 2414, the UE transmits SRS to the BS. In 2416, the BS measures SRS and estimates UL channel: J. In 2418, the BS determines UL cov. Matrix: K_{SRS}=JJ*(N_{UL}×N_{UL}). In 2420, the BS determines UL eigenvector: w1. In 2422, the UE transmits UL-related report and signal (S) part of UL SINR. In 2424, the BS determines SINR=S/(1+N) and determines UL MCS. In 2426, the BS determines UL interference: I. In 2428, the BS transmits UL grant: MCS, UL RA to the UE. In 2430, the UE determines/performs UL precoding. In 2432, the UE determines UL data. In 2434, the UE transmits UL transmission to the BS. In 2436, the BS receives the UL reception.

In one embodiment, as a variation of scheme C1 (described in one or more embodiments herein), shown in FIG. 24, the procedure includes an additional step on SRS transmission from the UE. The UE can estimate UL channel (denoted as J) based on SRS measurement. The eigenvectors {wₗ} of the UL channel J can approximate (left) UL eigenvectors vₗ determined at the UE based on CSI-RS measurement, as described herein. In one example, UL SINR can be calculated by the NW/gNB based on the received S, UL interference I, and UL channel J (may also be based on eigenvectors wₗ determined based on J). The UL MCS can then be selected based on the calculated UL SINR. In one example,

$$SINR = \frac{ζ}{I + N}$$

where ζ is a function of S, J, wₗ or S, J. For example, for rank 1, ζ=S∥Jw₁∥² or S∥J∥². Or, for rank 1, ζ=x₁S+x₂∥Jw₁∥² or x₁S+x₂∥J∥² where x₁ and x₂ are two weights such that x₁+x₂=1 and 0≤xᵢ≤1. The rest of the details in one or more embodiments described herein apply to this embodiment as well, hence omitted for brevity.

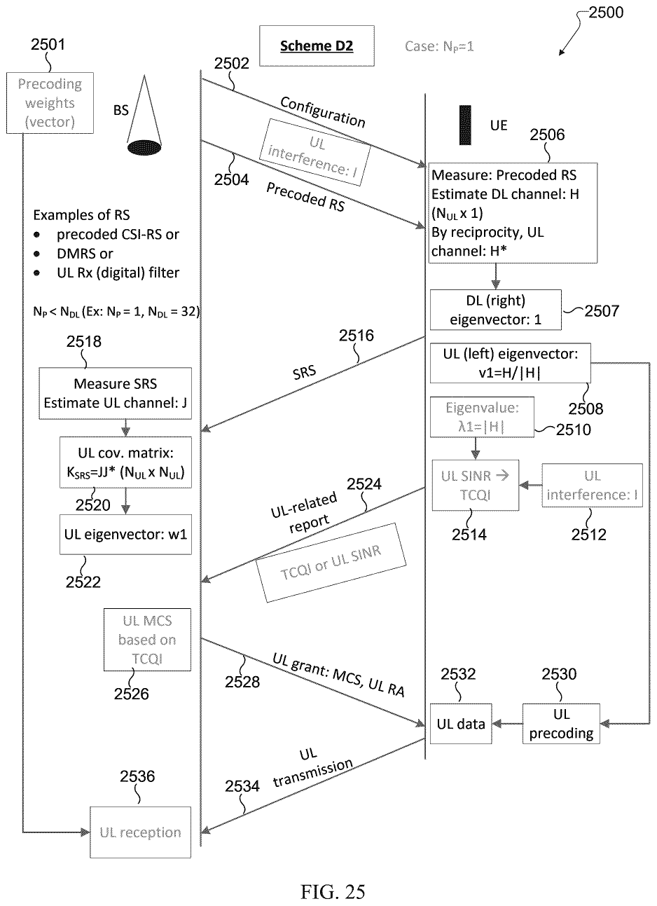

FIG. 25 illustrates a signal flow of an example procedure 2500 for UL-related reporting according to embodiments of the present disclosure. For example, procedure 2500 can be performed by the UE 112 and the gNB 102 and/or network 130 in the wireless network 100 of FIG. 1. This example is for illustration only and other embodiments can be used without departing from the scope of the present disclosure.

The procedure begins in 2501, a BS determines precoding weights (vector). In 2502, the BS transmit a configuration and UL interference: I to a UE. In 2504, a BS transmits a precoded RS to the UE. In 2506, the UE measures precoded RS, estimates the DL channel H (N_{UL}×1), and by reciprocity estimates the UL channel H*. In 2507, the determines DL (right) eigenvector: 1. In 2508, the UE determines UL (left) eigenvector: v1=H/|H|. In 2510, the UE determines Eigenvalue: λ₁=|H|. In 2512, the UE determines UL interference: I. In 2514, the UE determines UL SINR and TCQI. In 2516, the UE transmits SRS to the BS. In 2518, the BS measures SRS and estimates UL channel: J. In 2520, the BS determines UL cov. Matrix: K_{SRS}=JJ*(N_{UL}×N_{UL}). In 2522, the BS determines UL eigenvector: w1. In 2524, the UE transmits UL-related report and TCQI or UL SINR to the BS. In 2526, the BS determines UL MCS based on TCQI. In 2528, the BS transmits UL grant: MCS, UL RA to the UE. IN 2530, the UE determines/performs UL precoding. In 2532, the UE determines UL data. In 2534, the UE transmits UL transmission to the BS. In 2536, the BS receives the UL transmission.

In one embodiment, as a variation of scheme D1 (described in one or more embodiments herein), shown in FIG. 25, the procedure includes an additional step on SRS transmission from the UE. The UE can estimate UL channel (denoted as J) based on SRS measurement. The eigenvectors {wₗ} of the UL channel J can approximate (left) UL eigenvectors v determined at the UE based on CSI-RS measurement, as described herein. In one example, UL SINR can be calculated by the NW/gNB based on the received TCQI (received UL SINR, denoted as SINRᵣₓ), and UL channel J (may also be based on eigenvectors wₗ determined based on J). The UL MCS can then be selected based on the calculated UL SINR. In one example, the calculated SINR=γ where γ is a function of SINRᵣₓ, J, wₗ or SINRᵣₓ, J. For example, for rank 1, γ=SINRᵣₓ∥Jw₁∥² or SINRᵣₓ∥J∥². Or, for rank 1, γ=x₁SINRᵣₓ+x₂∥Jw₁∥² or x₁SINRᵣₓ+x₂∥J∥² where x₁ and x₂ are two weights such that x₁+x₂=1 and 0≤xᵢ≤1. The rest of the details in one or more embodiments described herein apply to this embodiment as well, hence omitted for brevity.

In one embodiment, a UE is configured with the measurement and reporting according to one of embodiments of this disclosure, wherein the CSI-RS measurement and (CSI) reporting band (e.g. a set of PRBs) for calculating S or UL SINR or UL MCS or TCQI is according to at least one of the following examples.
In one example, the reporting band is a target UL BW (or UL RA) for UL transmission.
In one example, the reporting band is included in or equal to an “active” UL BWP.
In one example, the reporting band is included in or equal to an SRS BW.
In one example, the reporting band and the target UL BW or active UL BWP or SRS BW can overlap partially.
   In one example, the measurement and report can correspond to the overlapped PRBs (expecting no interpolation/extrapolation).
   In one example, the measurement and report can correspond to both overlapping and non-overlapping PRBs. The UE is expected to perform extrapolation/interpolation or prediction in the non-overlapping PRBs.

The UE complexity associated with the report (as described herein) depends on number of singular value decompositions (SVDs) or eigenvalue decompositions (EVDs). Note that one SVD is equivalent to two EVDs (left and right). In particular, the full explicit CSI is based on a set of triples {λᵢ, uᵢ, vᵢ}. T the DL/UL channels can be approximated (up to a few layers) as follows: (DL)

$$\tilde{H} \sim \sum {λ}_{i} {v}_{i} {u}_{i}^{*}$$

$$and$$

$${\tilde{H}}^{*} \sim \sum {λ}_{i} {u}_{i} {v}_{i}^{*} .$$

Since the report is per SB (for each SB in the CSI reporting band), the UE performs SVD/EVD in each SB. The UE complexity can be large when the size of the measured DL channel or/and number of SBs are large. To reduce UE complexity, an alternative scheme could be based on only one EVD (either left or right EVD). A few examples of such reduced complexity schemes are described in this disclosure.

In one embodiment, a UE determines DL eigenvectors u₁, u₂, . . . based on EVD(H*H), where H is estimated DL channel based on the measurement of the at least one NZP CSI-RS. The corresponding UL eigenvectors can be approximated as

$${\tilde{v}}_{i} \sim \frac{1}{{λ}_{i}} {Hu}_{i} .$$

Note that \tilde{v}ᵢ approximates UL eigenvector vᵢ which ideally is determined based on EVD(HH*).

In one embodiment, a variation of one or more embodiments described herein, the UE reports {λᵢ} together with DL CSI (e.g. per layer DL precoder), then NW can approximate the UL precoder as

$${\tilde{v}}_{i} \sim \frac{1}{{λ}_{i}} {Hu}_{i} ,$$

where uᵢ is based on DL PMI, and H can be estimated based on SRS measurement.

In one embodiment, a UE (e.g., the UE 116) determines UL eigenvectors v₁, v₂, . . . based on EVD(HH*), where H is estimated DL channel based on the measurement of the at least one NZP CSI-RS. The corresponding DL eigenvectors can be approximated as

$${\tilde{u}}_{i} \sim \frac{1}{{λ}_{i}} {H}^{*} {v}_{i}$$

$$or$$

$${\tilde{u}}_{i}^{*} \sim \frac{1}{{λ}_{i}} {v}_{i}^{*} H .$$

Note that ũᵢ approximates DL eigenvectors uᵢ which ideally is determined based on EVD(H*H).

In one embodiment, a variation of one or more embodiments described herein, the UE reports {λᵢ} together with UL CSI (e.g. per layer UL precoder), then NW can approximate DL precoder as

$${\tilde{u}}_{i} \sim \frac{1}{{λ}_{i}} {H}^{*} {v}_{i} ,$$

where vᵢ is based on UL CSI, and H can be estimated based on SRS measurement.

The present disclosure relates to reciprocity-based UL transmission. The disclosure includes the following:
UL interference measurement and indication from NW to the UE
Details on UL interference metric/quantity
Linkage between SRS and CSI-RS for target reciprocity-based schemes
Signaling details

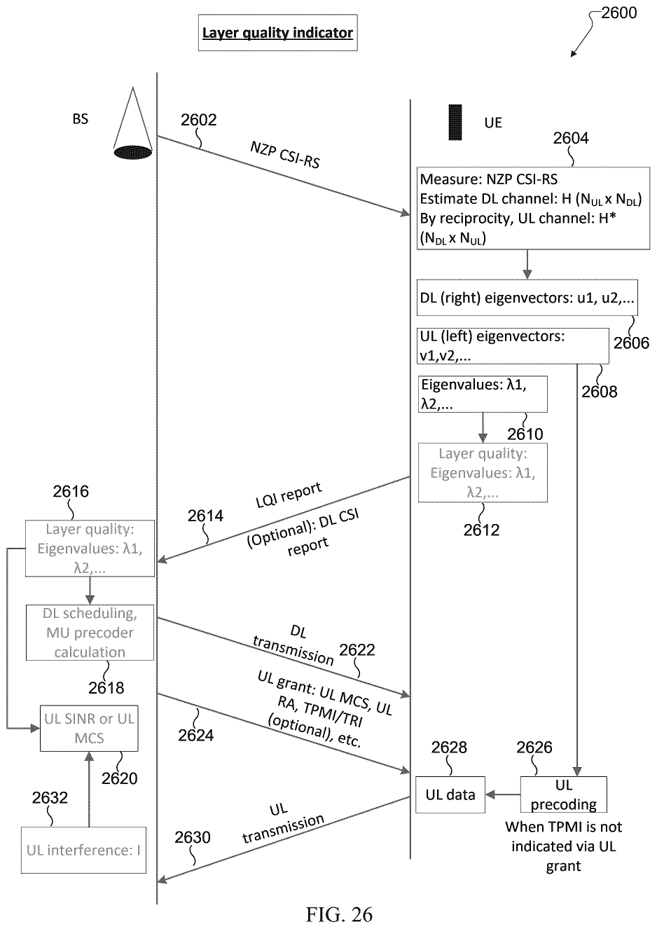

FIG. 26 illustrates a signal flow of an example procedure 2600 for indicating layer quality according to embodiments of the present disclosure. For example, procedure 2600 can be performed by the UE 113 and the gNB 102 and/or network 130 in the wireless network 100 of FIG. 1. This example is for illustration only and other embodiments can be used without departing from the scope of the present disclosure.

The procedure begins in 2602, a BS transmits a NZP CSI-RS to a UE. In 2604, the UE measures the NZP CSI-RS, estimates the DL channel H (N_{UL}×N_{DL}), and by reciprocity estimates the UL channel H*(N_{DL}×N_{UL}). In 2606, the UE determines DL (right) eigenvectors u₁, u₂, . . . . In 2608, the UE determines UL (left) eigenvectors v₁, v₂, . . . . In 2610, the UE determines eigenvalues λ₁, λ₂, . . . . In 2612, the UE determines layer quality: Eigenvalues λ₁, λ₂, . . . . In 2614, the UE transmits a LQI report and (optional): DL CSI report. In 2616, the BS determines/identifies layer quality: Eigenvalues λ₁, λ₂, . . . . In 2618, the BS determines DL scheduling, MU precoder calculation. In 2620, the BS determines UL SINR or UL MCS. In 2622, the BS transmits a DL transmission to the UE. In 2624, the BS transmits UL grant: UL MCS, UL RA, TPMI/TRI (optional), etc. to the UE. In 2626, the UE determines/performs UL precoding. In 2628, the UE determines UL data. In 2630, when TPMI is not indicated via UL grant, the UE transmits UL transmission to the BS. In 2632, the BS determines UL interference: I.

When DL and UL channels are reciprocal (e.g. in TDD scenarios), the report quantity can be for both DL-related and UL-related. This is due to the fact that the layer quality/strength of a layer can be applied to (or associated with) either a DL layer or a corresponding UL layer. An illustration of utilizing layer quality report for the two use cases (mentioned herein) is shown in FIG. 26. As shown, the UE based on the DL RS measurement can determine DL (right) and UL (left) eigenvectors and corresponding eigenvalues {(uₗ, vₗ, λₗ)}, report LQI indicating (quantized) eigenvalues {λₗ} or an information about them. The UE can also include DL CSI (e.g. RI, CQI, PMI) in the report. NW/gNB (e.g., the network 130/the BS 102) upon receiving the LQI can determine the layer quality, and apply/utilize it for (a) DL scheduling or/and MU precoding calculation for subsequent DL transmission(s), or (b) UL MCS selection to be indicated via an UL-grant for subsequent UL transmission(s). The UL-grant includes UL resource allocation (UL RA), and may optionally include at least one of UL rank (TRI) and UL precoding (TPMI). When TPMI is not included in the UL-grant, the UE can use the determined UL (left) eigenvectors {vₗ} for UL precoding. When TRI is not included in the UL-grant, the UL rank can be fixed (e.g. 1), or configured via higher layer (e.g. via PUSCH-Config).

In one embodiment, as shown in FIG. 15, an UL transmission scheme can be described as follows. When a UE is in coverage, the UL transmission is based on SRS akin to the SRS-based UL transmission scheme (where SRS is used for UL SINR as well as UL TPMI). Else, when the UE is located in coverage-limited/-edge region and the DL-UL reciprocity is feasible, the UE is configured with an UL-assisting/-related report, wherein the UE is configured with at least one NZP CSI-RS for acquiring/measuring accurate S (in coverage-limited scenarios), and the UE based on the measurement, determines a report including at least one indicator indicating S. The NW performs UL link adaptation for the UE based on received S and (SRS-based) estimated interference I.

In one example, the report is a high-res report wherein the report corresponds to a direct DL channel explicit feedback (per sub-band). In one example, the report is a low-res report wherein the report corresponds to an L1-RSRP (per sub-band).

The report can be a standalone report (i.e. not multiplexed with any other report or UCI parameter). In one example, the report can be a non-standalone report, hence can be multiplexed together with another report or UCI parameter. When multiplexed with another report or UCI parameter, another report can be a (DL) CSI report and the UCI parameter can be at least one of RI, PMI, CQI, LI, CRI, SSBRI, L1-RSRP, L1-SINR, and TDCP. In one example, the report can be standalone or non-standalone based on configuration (from the NW, e.g. RRC or/and MAC CE or/and DCI) or UE capability. In one example, the report can be a non-standalone report, and is a part of (included in) a (DL) CSI report, where the CSI report can include at least one of RI, PMI, CQI, LI, CRI.

In one embodiment, a UE receives a configuration or/and indication (e.g. an RRC message, IE, or parameter, or/and a DCI trigger or codepoint) including information about at least one NZP CSI-RS and an UL-related report. The UE, in response, measures the at least one NZP CSI-RS and based on the measurement, determines the UL-related report assuming that UL and DL channels are reciprocal (e.g. for TDD scenarios). The report includes an indicator (or UCI parameter) indicating a signal (S) part/component for UL SINR calculation, where the signal S can be based on eigenvalue(s) λ₁, . . . associated with υ≥1 layers, or based on estimated UL channel. The eigenvalue(s) can be based in DL channel estimation (based on the measurement of NZP CSI-RS) as described herein.

The NW/gNB, upon reception of the UL-related report, can use the signal S to calculate UL SINR when the UL interference I is available at the NW/gNB. The calculated UL SINR can then be used for UL MCS selection in order to improve UL link adaptation for upcoming UL transmission(s) (e.g. via DCI with UL-grant for PUSCH transmission). The UL-grant includes UL resource allocation (UL RA), i.e., a set of PRBs for UL transmission and the determined UL MCS. The UL-grant may optionally include at least one of UL rank (TRI) and UL precoding (TPMI). When TPMI is not included in the UL-grant, the UE can use the determined UL (left) eigenvectors {vₗ} for UL precoding. When TRI is not included in the UL-grant, the UL rank can be fixed (e.g. 1), or configured via higher layer (e.g. via PUSCH-Config).

In one embodiment, a UE receives a configuration or/and indication (e.g. an RRC message, IE, or parameter, or/and a DCI trigger or codepoint) including information about (i) UL interference I, (ii) at least one NZP CSI-RS, and (iii) an UL-related report. The UE, in response, measures the at least one NZP CSI-RS and based on the measurement and the UL interference I, determines the UL-related report assuming that UL and DL channels are reciprocal (e.g. for TDD scenarios). The report includes an indicator indicating a quality of UL channel. In one example, the quality of UL channel is quantified as UL SINR. In one example, the quality of UL channel is quantified as transmit CQI (TCQI). In one example, the quality of UL channel is quantified as UL MCS (TMCS). The UL SINR or TCQI or UL MCS is based on a signal (S) part/component and an interference part. The signal S can be based on eigenvalue(s) λ₁, . . . associated with υ≥1 layers, or based on estimated UL channel. The interference part is based on the UL interference I. The eigenvalue(s) can be based in DL channel estimation (based on the measurement of NZP CSI-RS) as described herein.

In one example, when the UL-related report includes UL SINR or TCQI, the NW/gNB, upon reception of the UL-related report, can use UL SINR or TCQI for UL MCS selection in order to improve UL link adaptation for upcoming UL transmission(s) (e.g. via DCI with UL-grant for PUSCH transmission). The UL-grant includes UL resource allocation (UL RA), i.e., a set of PRBs for UL transmission and the determined UL MCS. The UL-grant may optionally include at least one of UL rank (TRI) and UL precoding (TPMI). When TPMI is not included in the UL-grant, the UE can use the determined UL (left) eigenvectors {vₗ} for UL precoding. When TRI is not included in the UL-grant, the UL rank can be fixed (e.g. 1), or configured via higher layer (e.g. via PUSCH-Config).

As shown in FIG. 19, the timeline for receiving the UL interference I can be according to at least one of the following examples.
In example A, the UL interference I is provided together with the configuration. The NZP CSI-RS is received D₁ slots after receiving the configuration. The value of D₁ can be fixed, configured, or indicated via DCI.
   In one example, when the configuration is via RRC, the UL interference I can also be via RRC either as part of the configuration or a separate IE or RRC parameter.
   In one example, when the configuration is via RRC (e.g. CSI trigger state) which is triggered via a DCI, the UL interference can be via RRC either as part of the CSI trigger state or a separate IE or RRC parameter, or via the DCI (e.g. a codepoint of a DCI field).
In example B, the UL interference I is provided after the configuration but before CSI-RS. The UL interference I is received D₂ slots after receiving the configuration, and the NZP CSI-RS is received D₃ slots after receiving the UL interference I. The value of D₂ can be fixed, configured, or indicated via DCI. The value of D₃ can be fixed, configured, or indicated via DCI or determined based on the value of D₂.
In example C, the UL interference I is provided together with the NZP CSI-RS. The NZP CSI-RS and UL interference I are received D₁ slots after receiving the configuration. The value of D₁ can be fixed, configured, or indicated via DCI.
   In one example, when the configuration is via RRC, the UL interference I can also be via RRC either as part of the configuration for NZP CSI-RS or a separate IE or RRC parameter.
   In one example, when the configuration is via RRC (e.g. CSI trigger state) which is triggered via a DCI, the UL interference can be via RRC either as part of the CSI trigger state or as part of the configuration for NZP CSI-RS or a separate IE or RRC parameter, or via the DCI (e.g. a codepoint of a DCI field).
In example D, the UL interference I is provided after NZP CSI-RS. The NZP CSI-RS is received D₄ slots after receiving the configuration, and the UL interference I is received D₅ slots after receiving the NZP CSI-RS. The value of D₄ can be fixed, configured, or indicated via DCI. The value of D₅ can be fixed, configured, or indicated via DCI or determined based on the value of D₄. In one example, the value of D₅ is such that the UL interference is received in a slot either before or no later than the slot of the CSI reference resource.

In the rest of the disclosure, embodiments and examples are described for UL interference (I) measurement and indication. In the following, an UL SINR can be defined as:

$$SINR = \frac{S}{I + N}$$

or as

$$SINR = {\sum }_{k ∈ X} \frac{S ( k )}{I ( k ) + N ( k )}$$

where X is a set of subcarriers.

In one example, the UE determines the SRS transmission power (P_{SRS}) in an SRS transmission occasion as P_{SRS}=min(P_{CMAX},P), where P_{CMAX} is the UE configured maximum output power (in dBm), and P=P₀+10 log₁₀(2^{μ}M)+α·PL+h,
M is a SRS bandwidth expressed in number of resource blocks,
P₀, α are provided by RRC parameters p0 and alpha
μdetermines a subcarrier spacing (SCS) (e.g. 2^{μ}×15 kHz)
PL is a downlink pathloss estimate in dB calculated by the UE using a DL RS
h is a SRS power control adjustment (e.g. can be equal to PUSCH power control adjustment).

In one example, L1-received signal strength indicator (RSSI) is defined as linear average of the total received power (in [W]) observed only in the configured OFDM symbols of the configured measurement time resource(s), in the configured measurement bandwidth from sources, including co-channel serving and non-serving cells, adjacent channel interference, thermal noise etc. For frequency range 1, the reference point for the RSSI is the antenna connector of the UE or NW. For frequency range 2, L1-RSSI is measured based on the combined signal from antenna elements corresponding to a given receiver branch. For frequency range 1 and 2, if receiver diversity is in use by the UE or NW, the reported L1-RSSI value is not be lower than the corresponding L1-RSSI of any of the individual receiver branches.

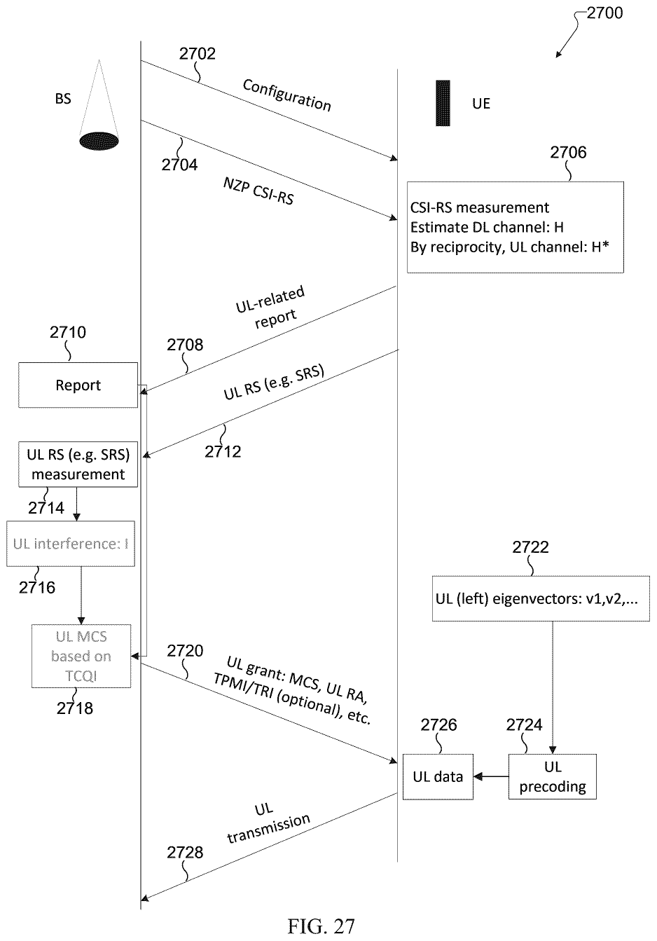

FIG. 27 illustrates a signal flow of an example procedure 2700 for UL-related reporting according to embodiments of the present disclosure. For example, procedure 2700 can be performed by the UE 114 and the gNB 102 and/or network 130 in the wireless network 100 of FIG. 1. This example is for illustration only and other embodiments can be used without departing from the scope of the present disclosure.

The procedure begins in 2702, a BS transmits a configuration to a UE. In 2704, a BS transmits a NZP CSI-RS to the UE. In 2706, the UE measures CSI-RS, estimates DL channel: H, and by reciprocity estimates the UL channel H*. In 2708, the UE transmits an UL-related report to the BS. In 2710, the BS receives/identifies the report. In 2712, the UE transmits a UL RS (e.g., SRS) to the BS. In 2714, the BS measures UL SRS (e.g., SRS). In 2716, the BS determines UL interference: I. In 2718, the BS determines UL MCS based on TCQI. In 2720, the BS transmits UL grant: UL MCS, UL RA, TPMI/TRI (optional), etc. to the UE. In 2722, the UE determines UL (left) eigenvectors v₁, v₂, . . . . In 2724, the UE determines/performs UL precoding. In 2726, the UE determines UL data. In 2728, the UE transmits UL transmission to the BS.

In one embodiment, as shown in FIG. 27, a UE is configured to (i) receive CSI-RS, and (2) transmit UL RS (e.g. SRS) or/and UL channel (physical uplink control channel (PUCCH) or/and PUSCH). The UE estimates DL channel based on CSI-RS measurement, and using reciprocity, obtains the UL channel estimate based on the DL channel (e.g. the UL channel can be estimated as a scaled version of a transpose/Hermitian of the estimated DL channel). The UE then determines the UL-related report and transmits it to the NW. The NW estimates UL interference (denoted as I) based on UL RS (e.g. SRS) measurement or/and UL channel (PUCCH or/and PUSCH). The estimated UL interference I or/and the UL-related report (from the UE), as described herein, are used by the NW to determine UL SINR and MCS.

The UL interference (I) can be estimated based on the at least one of the following examples.
In one example, the UL RS is a zero power (ZP) SRS. The ZP SRS can be an explicit/dedicated SRS (similar to ZP CSI-RS for DL). Or, the UE is configured with the SRS, but it's power can be adapted/changed separately (e.g. via a dedicated RRC parameter or a MAC CE or a DCI field). For instance, the ZP can be achieved according to at least one of the following examples. In one example, the number of SRS ports is fixed (e.g. 1 or 2) when the SRS is configured/used for interference measurement.
   In one example, the configured SRS power P_{SRS} is so small that SRS can't be received/measured by the NW.
   In one example, the SRS REs (REs allocated to the SRS) are muted when SRS is used for UL interference measurement, i.e., the UE is configured/indicated separately whether to mute (do not transmit) SRS.
In one example, the UL RS is a non-ZP (NZP) SRS, and the SRS power P_{SRS} is sufficiently large (for the NW to receive/measure). In this case, the NW uses the received UL signal (y) to estimate a desired signal (d) based on the NZP SRS measurements, subtracts d from y, i.e., z=y−d, and then uses z to estimate UL interference. In one example, such an NZP SRS can be configured (via RRC) as an UL interference measurement resource (IMR), i.e. as NZP SRS for UL interference measurement. In one example, such an NZP SRS can be indicated (via MAC CE) as an UL interference measurement resource (IMR), i.e. as NZP SRS for UL interference measurement. In one example, such an NZP SRS can be indicated (via DCI) as an UL interference measurement resource (IMR), i.e. as NZP SRS for UL interference measurement.
In one example, the UL RS is a DMRS. In one example, the DMRS is a PUCCH DMRS. In one example, the DMRS is a PUSCH DMRS. When number of PUCCH or PUSCH DMRS ports is more than one, one of the multiple DMRS ports can be used for UL interference measurement (e.g. the one port can be fixed such as the first DMRS port), or, the multiple DMRS ports can be used for UL interference measurement.
In one example, a subset of the UL channel (PUCCH or/and PUSCH) REs can be muted, i.e., the UE is configured/indicated separately whether to mute (do not transmit) the UL channel on those REs. In one example, the subset corresponds one or more than one PRBs.
In one example, the UL RS is a L1-RSSI measurement RS (or resource).
In one example, the UL RS is a dedicated UL interference measurement RS (UL IMR). In one example, the UL IMR can only be configured in the UL SB. In one example, the time-frequency (T-F) allocation (patterns), i.e., set of REs in each PRB within the SRS band is the same as the T-F pattern/allocation for at least one of DL IMRs (e.g. NZP CSI-RS based IMR or CSI-IM based IMR).

In one example, UL interference is estimated based on muted UL PUSCH RE(s).
In one example, the granularity is at a symbol level, i.e., Z symbol(s) in a slot for a PUSCH is used.
   In one example, Z can be fixed, e.g. 1.
   In one example, the symbols(s) can be fixed, e.g. last Z symbol(s) of the slot, i.e. symbols with time indices 14−Z+1, . . . 14.
   In one example, the symbol(s) are symbol(s) of an SRS. The SRS ID is included in the UL-grant. A set/list of SRS ID(s) are configured, and one from the list is indicated via MAC CE or/and UL-DCI. The Z symbol(s) corresponds to time indices of symbol(s) of the indicated SRS.
In one example, the granularity is at a RE level, i.e., Y REs in Z symbol(s) in a slot for a PUSCH is used.
   In one example, Y can be fixed, e.g. 1. In one example, Z can also be fixed (e.g. 1).
   In one example, the RE(s) can be fixed, e.g. 1 RE per slot of last Z symbol(s) of the slot, i.e. symbols with time indices 14−Z+1, . . . 14 (total Y=Z REs).
   In one example, the RE(s) are RE(s) of an SRS (e.g. ZP SRS). The SRS ID is included in UL-grant. A set/list of SRS ID(s) are configured, and one from the list is indicated via MAC CE or/and UL-DCI. The Y RE(s) correspond to RE(s) of the indicated SRS.
   In one example, a comb-like RE pattern in Z symbols is used. The patterns can be fixed or configured.
In one example, the granularity is at a RE level, i.e., Y REs in Z symbol(s) in a slot for a PUSCH is used.
   In one example, a set of RE(s) is configured. In one example, a pattern of RE(s) is configured.
In one example, to determine the time location of UL muting symbol(s) in a slot for a PUSCH, the following scheme is selected for DG PUSCH and Type 2 configured grant (CG) PUSCH
   Scheme: The time location of each of one or two UL muting symbols is semi-statically configured, and muting the semi-statically configured time location of UL muting symbol(s) can be dynamically turned ON/OFF by time domain resource assignment (TDRA) field in DCI.

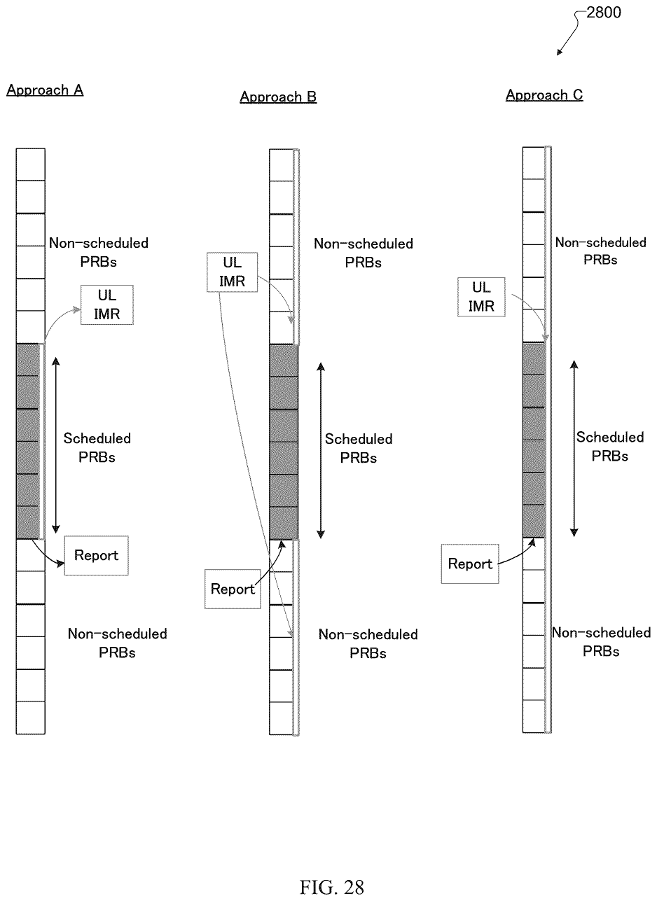

FIG. 28 illustrates examples of FD allocations 2800 according to embodiments of the present disclosure. For example, FD allocations 2800 can be utilized by any of the UEs 111-116 of FIG. 1, such as the UE 111. This example is for illustration only and other embodiments can be used without departing from the scope of the present disclosure.

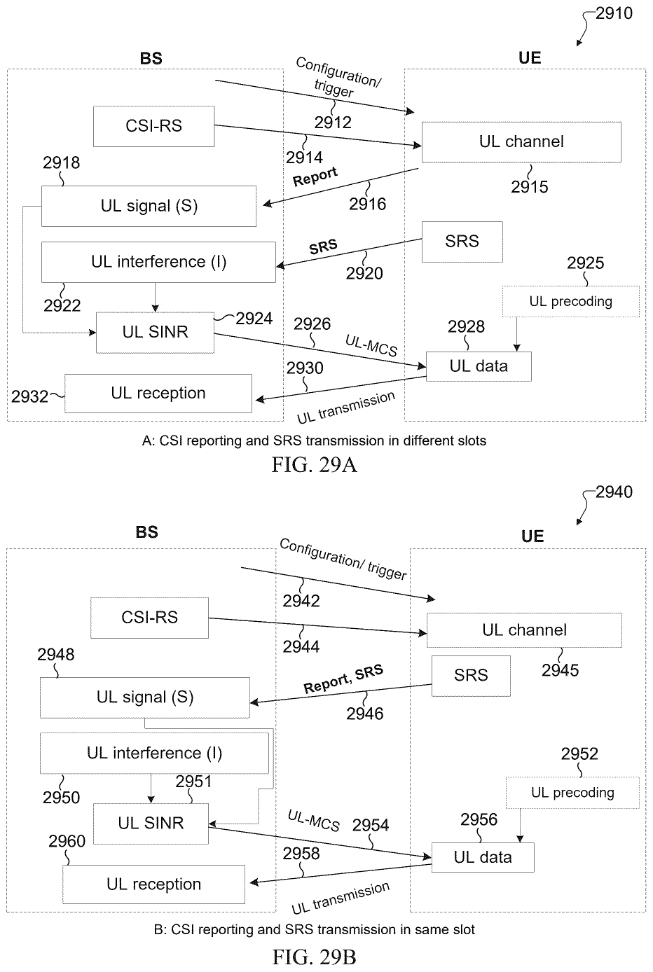

FIGS. 29A and 29B illustrate signal flows of an example procedure 2910 and 2940 for CSI reporting and SRS transmission according to embodiments of the present disclosure. For example, procedures 2910 and can be performed by the UE 115 and the gNB 102 and/or network 130 in the wireless network 100 of FIG. 1. This example is for illustration only and other embodiments can be used without departing from the scope of the present disclosure.

The procedure 2910 begins in 2912, a BS transmits a configuration/trigger to a UE. In 2914, the BS transmits a CSI-RS to the UE. In 2915, the UE determines/identifies an UL channel. In 2916, the UE transmits a report to the BS. In 2918, the BS determines/identifies UL signal (S). In 2920, the UE transmits SRS to the BS. In 2922, the BS determines/identifies UL interference (I). In 2924, the BS determines UL SINR. In 2925, the UE may determine/perform UL precoding. In 2926, the BS transmits UL-MCS to the UE. In 2928, the UE determines UL data. In 2930, the UE transmits UL transmission to the BS. In 2932, the BS receives the UL reception from the UE.

The procedure 2940 begins in 2942, a BS transmits a configuration/trigger to a UE. In 2944, the BS transmits CSI-RS to the UE. In 2945, the UE determines/identifies an UL channel. In 2946, the UE transmits a SRS report to the BS. In 2948, the BS determines/identifies UL signal (S). In 2950, the BS determines UL interference (I). In 2951, the BS determines UL SINR. In 2952, the UE may determine/perform UL precoding. In 2954, the BS transmits a UL-MCS to the UE. In 2956, the UE determines UL data. In 2958, the UE transmits an UL transmission to the UE. In 2960, the BS receives the UL reception.

In one example, UL interference measurement resource (UL IMR) corresponds to a set of REs S.
The frequency-domain (FD) allocation of the set of REs is according to at least one of the following approaches (cf. FIG. 28).
   In Approach A, the set S is within the UL RA (i.e., PRBs allocated for the UL transmission).
   In Approach B, the set S is outside the UL RA (i.e., PRBs not allocated for UL transmission).
   In Approach C, the set S is both inside and outside of the UL RA.
Time-domain [Desired to be as close to the CSI report slot as possible]
   Alt1: the set S is in UL RA slot
   Alt2: the set S is out of UL RA slot

In one example, the UL IMR for interference calculation I is either ZP SRS or muted PUSCH RE(s). The pros and cons of using them is tabulated in Table 15.

In one example, the interference calculation I is based on the Approach A and ZP SRS (as UL IMR). In one example, the interference calculation I is based on the Approach A and muted PUSCH RE(s). In one example, the interference calculation I is based on the Approach C and ZP SRS (as UL IMR).

TABLE 15

| | ZP SRS | PUSCH MUTING |
|---|---|---|
| Time allocation | More flexible (can be | Restricted (inside UL RA slot) |
| (symbol/slot) | inside/outside of UL RA | |
| | slot) | |
| Frequency allocation | More flexible (can be | Restricted (inside UL RA PRB(s)) |
| (REs) | inside/outside of UL RA | |
| | PRB(s)) | |
| P1: dependency/coupling | Two options: | P1: yes, P2: no; resources are |
| with UL RA? | Option 1: | taken from |
| P2: additional resource | P1: yes, SRS is within UL | CG PUSCH, IMR RE(s) is |
| (other than UL RA) | RA, (UL RA is needed) | signaled via |
| needed? | P2: no (same as | RRC: resource inefficient |
| | muted PUSCH or | DCI: OK (requires a DCI field) |
| | Approach A) | DG PUSCH: requires DCI field |
| | P2: yes (Approach C) | |
| | Option 2: | |
| | P1: no (UL RA not needed) | |
| | P2: yes, additional | |
| | UL resource for AP | |
| | SRS | |

In one example, for ZP SRS (akin to DL IMR), SRS REs are muted or P is too small to be received by NW. The RRC-based SRS configuration [with SRS ID] or aperiodic (AP)-SRS trigger state is used. The AP SRS trigger is via ‘SRS request’ in UL DCI.

In one example, for muted PUSCH RE(s), PUSCH REs are muted (no transmission). In one example, scheme(s) for the cross-link interference (CLI) measurement at the gNB (e.g., the BS 102) based on muted PUSCH RE(s) in subband full duplex (SBFD) duplex scenario is used for this purpose UL interference measurement.

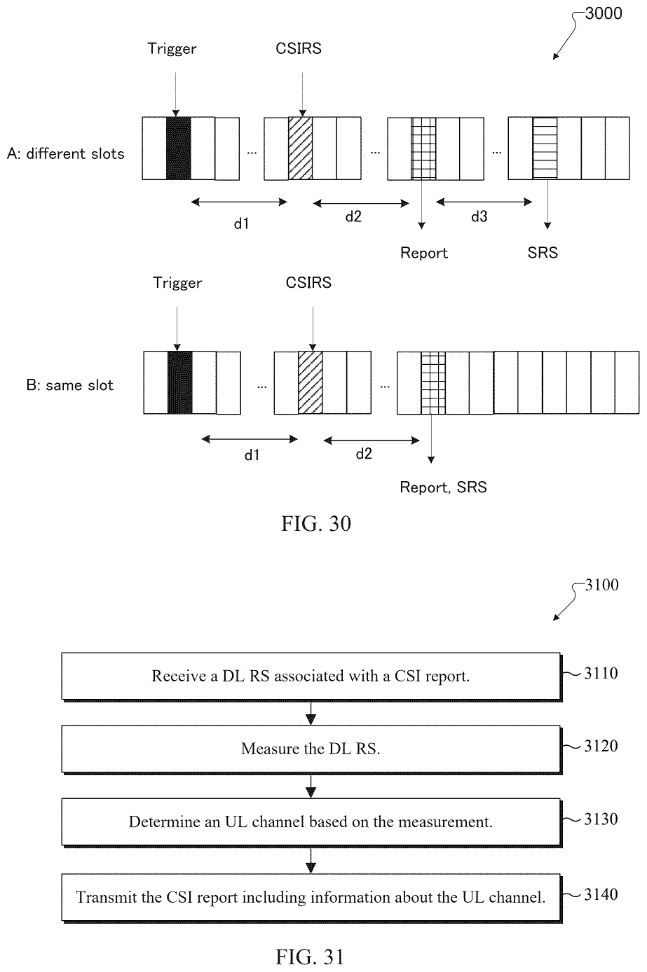

FIG. 30 illustrates examples triggers 3000 for CSI reporting and SRS transmission according to embodiments of the present disclosure. For example, triggers 3000 can trigger any of the UEs 111-116 of FIG. 1, such as the UE 116. This example is for illustration only and other embodiments can be used without departing from the scope of the present disclosure.

In one example, linkage between AP CSI-RS/report, and SRS transmission (as described in this disclosure, cf. FIG. 30) is via joint trigger in an UL-DCI. In one example, both d3=0 and d3>1 are provided.

In one example, a joint triggering of UL-assisting report and UL IMR is via UL-DCI.
When UL IMR=AP SRS, SRS power=0. Both cases (A) d3>0 and (B) d3=1 are provided.
When UL IMR=UL IMR=muted PUSCH RE(s), CLI measurement based on muted PUSCH RE(s) in SBFD duplex scenario is used for this purpose. In this case, (B) d3=0.

In one embodiment, the UE (e.g., the UE 116) is configured with a linkage between NZP CSI-RS or/and report, and UL RS (e.g. SRS).

In one example, the report is an aperiodic (AP) report, and the UL RS is an AP SRS.
In one example, there is a joint trigger/codepoint via a DCI which triggers both AP report and AP SRS.
   In one example, the joint trigger/codepoint is via an SRS request field in a DCI (e.g. UL DCI format)
   In one example, the joint trigger/codepoint is via a CSI request field in a DCI (e.g. UL DCI format)
   In one example, the joint trigger/codepoint is a dedicated DCI field in a DCI (either DL DCI format or UL DCI format).
In one example, there are two separate triggers/codepoints for AP report and AP SRS.
   In one example, the two separate triggers/codepoints are two DCI fields of a DCI.
   In one example, the two separate triggers/codepoints are two DCI fields of two DCIs (one per DCI).

In one example, the NZP CSI-RS is an aperiodic (AP) NZP CSI-RS, and the UL RS is an AP SRS.
In one example, there is a joint trigger/codepoint via a DCI which triggers both AP NZP CSI-RS and AP SRS.
   In one example, the joint trigger/codepoint is via an SRS request field in a DCI (e.g. UL DCI format)
   In one example, the joint trigger/codepoint is via a CSI request field in a DCI (e.g. UL DCI format)
   In one example, the joint trigger/codepoint is a dedicated DCI field in a DCI (either DL DCI format or UL DCI format).
In one example, there are two separate triggers/codepoints for AP NZP CSI-RS and AP SRS.
   In one example, the two separate triggers/codepoints are two DCI fields of a DCI.
   In one example, the two separate triggers/codepoints are two DCI fields of two DCIs (one per DCI).

In one example, the timeline (slots) of CSI/CSI-RS and SRS are according to at least one of the following examples.
In one example, as shown via example A in FIG. 29, the UE receives a CSI report trigger in a slot (shown in black), measures CSI-RS in a slot after d1 slots (from the trigger), determines the report, transmits the report in a slot after d2 slots (from the CSI-RS), and finally transmit SRS in a slot after d3 slots (from the report). When CSI-RS is AP, the CSI-RS slot d1 can be determined based on a CSI-RS slot offset value from a reference slot (e.g. the triggering slot). In one example, d2 is based on a value n_{csi,ref} associated with a CSI reference resource (as described herein). In one example, d2=n_{csi,ref}.
   In example, the SRS slot (value of d3) is determined implicitly based on the CSI reporting slot or/and the CSI-RS slot or/and the triggering slot.
   In example, the SRS slot (value of d3) is determined explicitly, e.g. an SRS slot offset value from a reference slot is configured (via RRC) or indicated via MAC CE or DCI. The reference slot can be the CSI reporting slot or the CSI-RS slot or the triggering slot or the CSI reference resource slot (the last slot at or before which the CSI-RS slot can be located). In one example, the CSI reference resource is n_{csi,ref} slots earlier than the CSI reporting slot, i.e., n_{ref}=nᵣₑₚₒᵣₜ−n_{csi,ref}.
In one example, as shown via example B in FIG. 29, the UE receives a CSI report trigger in a slot (shown in black), measures CSI-RS in a slot after d1 slots (from the trigger), determines the report, and transmits both the report and the SRS in a slot after d2 slots (from the CSI-RS). When CSI-RS is AP, the CSI-RS slot d1 can be determined based on a CSI-RS slot offset value from a reference slot (e.g. the triggering slot). In one example, d2 is based on a value n_{csi,ref} associated with a CSI reference resource (as described herein). In one example, d2=n_{csi,ref}.
In one example, the SRS slot can be earlier than the CSI report slot or/and CSI-RS slot.

In one example, the report is an aperiodic (AP) report, and the UL RS is a semi-persistent (SP) or a periodic (P) SRS. The linkage between the two can be according to at least one of the following examples
In one example, an information about the SP/P SRS (e.g. ID of IE SRS-config or SRS-Resource or an IE that configures the SRS) is included in an IE CSI-report-config (that configures the report) or an IE CSI-RS-config or NZP-CSI-RS (that configures the NZP CSI-RS), or an IE AperiodicCSITriggerState (that configures a list of trigger states for DCI-based CSI triggering).
In one example, an information about the CSI-RS (e.g. ID of CSI-RS-config or NZP CSI-RS) is included in an IE SRS-config (that configures a list of SRSs), or SRS-Resource (that configures the SRS).
In one example, at least one pair (SRS, NZP CSI-RS) or (SRS ID, NZP CSI-RS ID) is included in IE PUSCH-config (that configures PUSCH) or PUCCH-config (that configures PUCCH).

In one example, the linkage between the two (SRS, CSI-RS) is via MAC CE according to at least one of the following examples.
In one example, a set of pairs (SRS, NZP CSI-RS) or (SRS ID, NZP CSI-RS ID) are configured via RRC, and a MAC CE (UL MAC CE or DL MAC CE) is used to indicate one from the list as the linkage.
In one example, a pair (SRS, CSI-report-config) or (SRS ID, CSI-report-config ID) is indicated via a MAC CE (UL MAC CE or DL MAC CE).

In one embodiment, the report quantity (metric) for the UL interference indication from the NW to the UE, as described herein (cf. FIG. 19), is according to at least one of the following examples.
In one example, the report quantity is a power level (value) in linear scale or a logarithm scale (e.g. dB or dBm). The power can correspond to the interference power or interference covariance.
In one example, the report quantity is an interference covariance matrix of size Nᵣ×Nᵣ, where Nᵣ is a number of Rx antennae to receive UL transmission from the UE.
In one example, the report quantity is a few dominant directions (eigenvectors) that are based on the interference covariance matrix.
In one example, the report quantity is the interference channel of size Nᵣ×Nₜ where Nᵣ is a number of Rx antennae to receive UL transmission and Nₜ is a (total) number of Tx antennae (ports) at the interfering UE(s).

In one embodiment, the DL medium/channel for the UL interference indication from the NW to the UE, as described herein (cf. FIG. 19), is according to at least one of the following examples.
In one example, the medium/channel is a DL MAC CE (via a physical downlink shared channel (PDSCH)).
In one example, the medium/channel is a DCI (via a PDCCH). The DCI can be a DL-DCI (e.g. a DCI format that schedules DL PDSCH assignment), or a UL-DCI (e.g. a DCI format that grants UL PUSCH).
In one example, the medium/channel is a MAC CE (or PDSCH) when the indication payload (number of bits) is high, and is a DCI (PDCCH) when the indication payload is low.
In one example, the medium/channel is a two-stage indication (Stage 1, Stage 2). The stage 1 indication has a fixed payload, and includes an information about the stage 2 payload.
   In one example, (Stage 1, Stage 2)=(PDCCH, PDSCH).
   In one example, (Stage 1, Stage 2)=(PDCCH1, PDDCH2), where PDCCH1 and PDCCH2 are two stages of a two-stage DCI. The two-stage DCI can a single DCI with two stages (in the same slot), or two DCIs (in the same or two different slots).

In one embodiment, the UL interference indication from the NW to the UE is (triggered) based on a condition or event.
In one example, the condition/event is based on whether the NW detects a change in UL interference condition (e.g. when interference is above a threshold).
In one example, the condition/event is based on whether the NW detects a degradation in UL link quality (e.g. UL Rx SINR or block error ratio (BLER) or error rate or decoding failures or number of hybrid automatic repeat request (HARQ) retransmissions/processes). This could be based on a threshold.

In one embodiment, the timeline for the UL interference indication from the NW to the UE, as described herein (cf. FIG. 19), is according to at least one of the following examples.
In one example, the UL interference indication is AP (e.g. via DCI or PDCCH).
In one example, the UL interference indication is P or SP (e.g. via MAC CE or RRC or PDSCH).
In one example, the UL interference indication is a combination of AP and P/SP. The AP indication is via DCI or PDCCH. The P/SP indication is via MAC CE or RRC or PDSCH.

In one embodiment, the granularity of the UL interference indication from the NW to the UE, as described herein (cf. FIG. 19), is according to at least one of the following examples.
In one example, the UL interference indication is WB i.e., one set of value(s) for PRBs in the UL BW or BWP.
In one example 2, the UL interference indication is frequency-selective, i.e., N>1 sets of value(s) for N parts of the UL BW or BWP. The each of the N parts can be a PRB, SB, PRG, or

$$\frac{{N}_{ULRA}}{N} PRBs ,$$

where N_{ULRA} is an UL RA.

FIG. 31 illustrates an example method 3100 performed by a UE in a wireless communication system according to embodiments of the present disclosure. The method 3100 of FIG. 31 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3100 is for illustration only and other embodiments can be used without departing from the scope of the present disclosure.

The method begins with the UE receiving a DL RS associated with a CSI report (3110). In various embodiments, the DL RS is NZP CSI-RS. The UE then measures the DL RS (3120). The UE then determines an UL channel based on the measurement (3130). In various embodiments, the UE measures a DL channel based on the DL RS and applies a reciprocity between the UL channel and the DL channel to determine the UL channel.

The UE then transmits the CSI report including information about the UL channel (3140). In various embodiments, the UE transmits a muted UL RS for UL interference measurement. In various embodiments, the UE receives, based on the UL channel and the muted UL RS, information indicating a MCS, an UL RA, and a TPMI and transmits an UL signal based on the MCS, UL RA, and the TPMI. In various embodiments, the muted UL RS is a ZP SRS. In various embodiments, the muted UL RS is included in a set of muted PUSCH REs.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive a downlink (DL) reference signal (RS) associated with a channel state information (CSI) report; and
a processor operably coupled to the transceiver, the processor configured to:
measure the DL RS, and
determine an uplink (UL) channel based on the measurement,
wherein the transceiver is further configured to transmit the CSI report including information about the UL channel.

2. The UE of claim 1, wherein the transceiver is further configured to transmit a muted UL RS for UL interference measurement.

3. The UE of claim 2, wherein the transceiver is further configured to:
receive, based on the UL channel and the muted UL RS, information indicating a modulation and coding scheme (MCS), an UL resource allocation (UL RA), and a transmit precoding indicator (TPMI), and
transmit an UL signal based on the MCS, UL RA, and the TPMI.

4. The UE of claim 2, wherein the muted UL RS is a zero-power (ZP) sounding reference signal (SRS).

5. The UE of claim 2, wherein the muted UL RS is included in a set of muted physical uplink shared channel (PUSCH) resource elements (REs).

6. The UE of claim 1, wherein the DL RS is non-zero power (NZP) CSI-RS.

7. The UE of claim 1, wherein:
the processor is further configured to measure a DL channel based on the DL RS, and
apply a reciprocity between the UL channel and the DL channel to determine the UL channel.

8. A base station (BS) comprising:
a transceiver configured to:
transmit a downlink (DL) reference signal (RS) associated with a channel state information (CSI) report; and
receive the CSI report including information about an uplink (UL) channel, wherein the UL channel is based on measurement of the DL RS.

9. The BS of claim 8, wherein the transceiver is further configured to receive a muted UL RS for UL interference measurement.

10. The BS of claim 9, wherein the transceiver is further configured to:
transmit, based on the UL channel and the muted UL RS, information indicating a modulation and coding scheme (MCS), an UL resource allocation (UL RA), and a transmit precoding indicator (TPMI), and
receive an UL signal based on the MCS, UL RA, and the TPMI.

11. The BS of claim 9, wherein the muted UL RS is a zero-power (ZP) sounding reference signal (SRS).

12. The BS of claim 9, wherein the muted UL RS is included in a set of muted physical uplink shared channel (PUSCH) resource elements (REs).

13. The BS of claim 8, wherein the DL RS is non-zero power (NZP) CSI-RS.

14. The BS of claim 8, wherein the UL channel is based on a reciprocity between the UL channel and a DL channel and measurement of the DL channel.

15. A method performed by a user equipment (UE), the method comprising:
receiving a downlink (DL) reference signal (RS) associated with a channel state information (CSI) report;
measuring the DL RS;
determining an uplink (UL) channel based on the measurement; and
transmitting the CSI report including information about the UL channel.

16. The method of claim 15, further comprising transmitting a muted UL RS for UL interference measurement.

17. The method of claim 16, further comprising:
receiving, based on the UL channel and the muted UL RS, information indicating a modulation and coding scheme (MCS), an UL resource allocation (UL RA), and a transmit precoding indicator (TPMI); and
transmitting an UL signal based on the MCS, UL RA, and the TPMI.

18. The method of claim 16, wherein the muted UL RS is a zero-power (ZP) sounding reference signal (SRS).

19. The method of claim 16, wherein the muted UL RS is included in a set of muted physical uplink shared channel (PUSCH) resource elements (REs).

20. The method of claim 15, wherein the DL RS is non-zero power (NZP) CSI-RS.
